(19) United States
(12) Patent Application Publication
(10) Pub. No.: US 2017/0113936 A1
(43) Pub. Date: Apr. 27, 2017

(54) Methods for Synthesizing Graphene from a Lignin Source

(71) Applicant: Mississippi State University, Starkville, MS (US)

(72) Inventors: Jilei Zhang, Starkville, MS (US); Qiangu Yan, Starkville, MS (US); Zhiyong Cai, Madison, WI (US)

(73) Assignee: The United States of America as Represented by the Secretary of Agriculture, Washington, DC (US)

(21) Appl. No.: 15/400,281

(22) Filed: Jan. 6, 2017

Related U.S. Application Data
(63) Continuation-in-part of application No. 14/297,275, filed on Jun. 5, 2014, now Pat. No. 9,540,244.
(60) Provisional application No. 61/831,297, filed on Jun. 5, 2013.

(51) Int. Cl. C01B 31/04; B01J 13/20; B01J 27/25; B01J 35/12; B01J 27/128; B01J 23/745; B01J 13/02; B01J 27/24

(52) U.S. Cl. CPC C01B 31/0446; B01J 13/02; B01J 13/20; B01J 27/25; B01J 27/24; B01J 35/12; B01J 27/128; B01J 23/745

(57) ABSTRACT

Processes, methods, and compositions for synthesizing carbon-based materials are provided. The method of synthesizing carbon-based materials includes providing precursors, forming carbon-encapsulated metal structures from the precursors, and forming nano-shell structure-based graphene materials from the carbon-encapsulated metal structures. The precursors are formed from a biomass and a catalyst, and may be pretreated prior to the forming of the carbon-encapsulated metal structures.

### RELATED APPLICATION

This application is a continuation-in-part of U.S. patent application Ser. No. 14/297,275, filed Jun. 5, 2014, now allowed, which claims priority from U.S. Provisional Patent Application No. 61/831,297, filed Jun. 5, 2013, the entire disclosures of which are incorporated herein by this reference.

### STATEMENT OF GOVERNMENT SUPPORT

The invention described herein was made with government support under grant Nos. 11-JV-11111124-097, 12-JV-11111124-091, and 15-JV-1111124-016 awarded by the USDA Forest Service. The government has certain rights in the invention.

### TECHNICAL FIELD

The presently-disclosed subject matter relates to processes, methods, and compositions for synthesizing carbon nanomaterials from carbon-containing resources. In particular, the presently-disclosed subject matter relates to the use of solid carbon-containing resources, such as biomass, for preparation of multi-layer nano-shell structure-based graphene materials.

### BACKGROUND

There are several methods for making graphene-based materials, including micromechanical cleavage of graphite; chemical exfoliation of graphite oxide; epitaxial growth of graphene on SiC surface; thermal annealing of solid carbon to graphene; and chemical vapor deposition (CVD). Of these methods, the CVD process is particularly promising due to its decreased cost and large-area graphene production.

During the CVD process, a hydrocarbon-based gas is fed into a reactor and passes through a hot zone, where the hydrocarbon precursor decomposes to carbon radicals at the metal substrate surface, and then forms single-layer or multi-layer graphene. The metal substrate not only works as a catalyst to lower the energy barrier of the reaction, but also determines the graphene deposition mechanism, which ultimately affects the quality of graphene.

In the past several years, a variety of transition metals such as Ni, Fe, and Cu have been demonstrated as the catalyst to synthesize graphene using CVD method. The graphene growth from iron is related to a dissolution and precipitation mechanism because Fe has high carbon solubility at a high temperature. Specifically, in a high temperature range (600-1000° C.), the hydrocarbon will decompose to carbon atoms and dissolve into Fe to form a C—Fe solid. The carbon solubility in Fe decreases as its temperature goes down. Therefore, carbon atoms diffuse out from bulk Fe and precipitate on the surface to form graphene sheets as the temperature decreases. The CVD graphene process from a nickel substrate is similar to Fe because Ni has high carbon solubility too. However, Cu has a very low carbon solubility which results in a different graphene formation mechanism. More specifically, the graphene growth on Cu is a surface absorption process. The hydrocarbon is catalytically decomposed to carbon atoms over a Cu surface. Once, the surface is covered by graphene layers, the growth stops.

The CVD process is limited to the use of gaseous species as its raw materials for carbon sources, which makes it difficult to apply the technology to a wider variety of potential carbon precursors such as carbon-based solid materials. In recent years, much research has yielded novel ways to synthesize graphene sheets by solid carbon feedstocks, such as poly (methyl methacrylate) (PMMA), polystyrene, and amorphous carbon. These processes are related to a thermal annealing mechanism, while large-scale graphene production is limited due to the requirement for either a coating of polymer on the catalyst surface or decomposition of a thin film of catalyst onto an amorphous surface. Additionally, these processes typically provide low product yield due to either carbon in the precursor escaping in gas form or existing in amorphous form, i.e., limited carbon in the precursor is converted into graphene-based materials.

In one alternative method, Zhou et al. reported that nitrogen doped graphene was synthesized by Fe²⁺ catalytic graphitization of milk powder. Although this initially appeared to be a promising way for scalable graphene production, the carbon precursor was not affordable. In another alternative method, the instant inventors previously synthesized graphene materials in powder form from low cost and easily available lignosulfonate using Fe nanoparticles as a catalyst. However, the yield and selectivity of graphene-based materials remain an obstacle for scalable graphene production.

Accordingly, there is a need for systems and methods that can selectively and efficiently convert lignins and/or sources thereof to carbon nanomaterials, such as graphene.

### SUMMARY

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of features.

The presently-disclosed subject matter provides, in some embodiments, a method of synthesizing carbon nanomaterials comprising providing precursors, forming carbon-encapsulated metal structures from the precursors, and forming nano-shell structure-based graphene materials from the carbon-encapsulated metal structures. In one embodiment, providing the precursors comprises preparing the precursors, such as, for example, by mixing a biomass and a catalyst. In another embodiment, mixing the biomass and the catalyst forms a catalyst-impregnated biomass. The biomass is selected from the group consisting of kraft lignin, organosolv lignin, lignosulfonates, black liquor, wood chips, wood char, starch, wood-derived sugars, active carbon, carbon black, and combinations thereof. The catalyst is a metal catalyst, such as a transition metal or salt thereof, selected from the group consisting of Fe, Cu, Ni, Co, Mo, W, and salts thereof.

In some embodiments, forming the carbon-encapsulated metal structures comprises thermally treating the precursors. In some embodiments, forming nano-shell structure-based graphene materials includes opening the carbon-encapsulated metal structures to form shell-like structures, then welding and reconstructing the shell-like structures to form the nano-shell structure-based graphene materials. In one embodiment, welding and reconstructing the shell-like structures comprises application of a welding reagent gas under high temperature, such as a temperature of between 600° C. and 1,500° C. In another embodiment, the welding reagent gas is selected from the group consisting of light hydrocarbons, argon, hydrogen, other carbonaceous gases, and combinations thereof. In a further embodiment, the nano-shell structure-based graphene materials comprise multi-layer graphene-based materials selected from the group consisting of nano-graphene shell connected chains, graphene nanoplatelets, fluffy graphene, flat graphene sheets, curved graphene sheets, graphene sponges, graphene-encapsulated metal, metal carbide nanoparticles, graphene strips with a common metal joint, and combinations thereof.

In some embodiments, the method of synthesizing carbon nanomaterials further comprises pretreating the precursor prior to forming the carbon-encapsulated metal structures. In one embodiment, the pretreating is selected from the group consisting of pre-decomposing the precursor, grinding the precursor, and a combination thereof.

In one embodiment, the method of synthesizing carbon-based materials comprises preparing precursors from a biomass and a catalyst, forming carbon-encapsulated metal structures from the precursors, the forming of the carbon-encapsulated metal structures including thermally treating the precursors, and forming nano-shell structure-based graphene materials from the carbon-encapsulated metal structures, the forming of the nano-shell structure based graphene materials including opening the carbon-encapsulated metal structures to form shell-like structures, then welding and reconstructing the shell-like structures to form the nano-shell structure-based graphene materials, wherein the biomass is selected from the group consisting of kraft lignin, organosolv lignin, lignosulfonates, black liquor, and combinations thereof, and wherein the catalyst is a transition metal.

In another embodiment, the method of synthesizing carbon-based materials comprises preparing precursors from a kraft lignin and a transition metal catalyst, pretreating the precursors, forming carbon-encapsulated metal structures from the precursors, the forming of the carbon-encapsulated metal structures including thermally treating the precursors, and forming nano-shell structure-based graphene materials from the carbon-encapsulated metal structures, the forming of the nano-shell structure based graphene materials including opening the carbon-encapsulated metal structures to form shell-like structures, then welding and reconstructing the shell-like structures to form the nano-shell structure-based graphene materials.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 includes a schematic illustration for the synthesis of multi-layer nano-shell structure-based graphene materials from carbon containing resources through catalytic thermal molecular welding method.

FIG. 2 includes a schematic showing a catalytic thermal molecular welding (CTMW) process.

FIG. 3 includes a schematic showing a reaction system according to an embodiment of the instant disclosure.

FIGS. 4A-D include schematics and images of typical products from a CTMW process. (A) schematic and images for multi-layer graphene chains. (B) schematic and images for multi-layer graphene nanoplatelets. (C) schematic and images for fluffy graphene. (D) schematic and images for flattened flake-like or curved shell-like.

FIG. 5 includes graphical images showing the effects of precursor particle size and heating time on product structures and morphology.

FIG. 6 includes a schematic showing a standardized procedure for preparation of precursors.

FIG. 7 includes a plot showing thermal gravimetric analysis (TGA) and differential thermo-gravimetric (DTG) curves of an iron-promoted lignin sample with a ramp rate of 10 ° C./min.

FIG. 8 includes a plot showing the evolution of gaseous products from iron-promoted lignin samples during temperature-programmed decomposition (TPD).

FIGS. 9A-I includes plots and images showing X-ray diffraction (XRD), scanning electron microscopy (SEM), and transmission electron microscopy (TEM) of products with different iron loading. (A) SEM image of product with 7.5% iron loading. (B) SEM image of product with 5% iron loading. (C) SEM image of product with 10% iron loading. (D) SEM image of product with 12.5% iron loading. (E) TEM image of product with 5% iron loading. (F) TEM image of product with 7.5% iron loading. (G) TEM images of product with 10% iron loading. (H) TEM image of product with 12.5% iron loading. (I) XRD plot.

FIGS. 10A-G include plots and images showing X-ray diffraction (XRD), scanning electron microscopy (SEM), and transmission electron microscopy (TEM) of products under different thermal treatment time. (A) SEM image of product with thermal treatment of 1 hour. (B) SEM image of product with thermal treatment of 3 hours. (C) SEM image of product with thermal treatment of 5 hours. (D) TEM image of product with thermal treatment of 1 hour. (E) TEM image of product with thermal treatment of 3 hours. (F) TEM images of product with thermal treatment of 5 hours. (G) XRD plot.

FIGS. 11A-I include plots and images showing X-ray diffraction (XRD), scanning electron microscopy (SEM), and transmission electron microscopy (TEM) of products with different precursor sizes. (A) SEM image of product with precursor size of between 250 and 420 μm. (B) SEM image of product with precursor size of between 177 and 250 μm. (C) SEM image of product with precursor size of between 125 and 177 μm. (D) SEM image of product with precursor size of between 44 and 125 μm. (E) TEM image of product with precursor size of between 250 and 420 μm. (F) TEM image of product with precursor size of between 177 and 250 μm. (G) TEM images of product with precursor size of between 125 and 177 μm. (H) TEM image of product with precursor size of between 44 and 125 μm. (I) XRD plot.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DEFINITIONS

Unless defined otherwise, all technical and scientific terms used herein have the same meaning as commonly understood by one of ordinary skill in the art to which the disclosure belongs. Any methods and materials similar to or equivalent to those described herein can be used in the practice or testing of the present disclosure, including the methods and materials are described below.

Following long-standing patent law convention, the terms “a,” “an,” and “the” refer to “one or more” when used in this application, including the claims. Thus, for example, reference to “a lignin source” includes a plurality of lignin sources, and so forth.

The terms “comprising,” “including,” and “having” are intended to be inclusive and mean that there may be additional elements other than the listed elements.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, percentage, or the like is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless otherwise stated, as used herein, “lignin” refers to lignin and sources thereof. Therfore, the term “lignin” includes, but is not limited to, kraft lignin (or thiolignin) and lignosulfonate (LS) from the pulping process, sulfur-free lignins from biomass conversion technologies, organosolv pulping, and soda pulping processes, and other lignin productions and derivatives from unusual plant sources or experimental pulping processes as known in the art.

The term “welding reagent molecules,” as used herein, refers these reactive gaseous molecules which have at least four functions under CTMW reaction conditions: 1) Weld or glue the smaller graphene shell pieces formed through carbon sources from biomass feedstocks like kraft lignin; 2) React amorphous carbons in biomass feedstocks to form gaseous carbon-containing molecules, and then followed by re-deposition to form multi-layer graphene-based materials; 3) Heal the defect of the graphene materials formed from biomass feedstocks like lignin; and 4) Be the part of welding reagents serving directly as a reactant to form carbon nano structures (carbon nanotubes, graphene).

The term “carbon-encapsulated metal nanoparticle,” as used herein, refers to a core/shell structure composed of a metal core and a carbon shell. The metal core may be composed of metal, metal carbide, or both. In some embodiments, the core has a diameter range of 2-20 nm. For example, in one embodiment, the core has a diameter in the range of 3-5 nm. The outer shell is composed of more than one layer of carbon atoms, which are arranged in a hexagonal crystalline structure with a graphitic type of bonding. In some embodiments, the outer shell has 2-30 of such single layer structures. For example, in one embodiment, the shell has 2-10 of the single layer structures.

The term “multi-layer graphene-based materials,” as used herein, refers to materials composed of more than one layer of carbon atoms, and arranged in a hexagonal crystalline structure with a graphitic type of bonding. These materials have a limited number of such single layer structures.

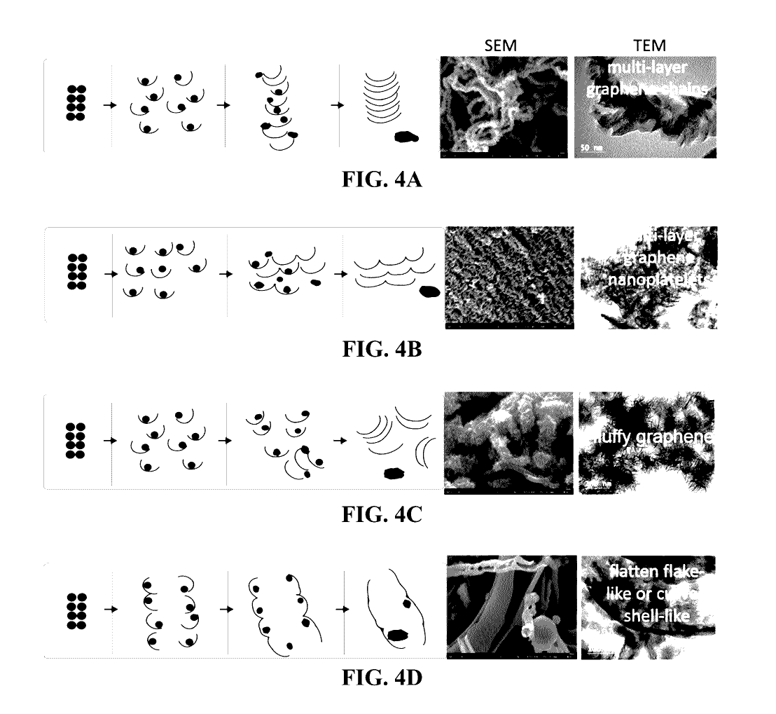

The term “multi-layer graphene chains,” as used herein, refers to a carbon-based nanomaterial having a one-dimensional graphic structure (FIG. 4A). The one-dimensional graphic structure is formed by “gluing” hundreds of multi-layer graphene chips along the perpendicular direction of the hexagonal plane. The multi-layer graphene chips are made up of 1 to 30 layers of graphene. The average thickness of the graphene chips is 10 nanometers or less. Dimensions in plane of the multi-layer graphene-based chips vary from several of nanometers to twenty nanometers. The length of the multi-layer graphene chain varies from hundreds of nanometers to over ten microns depending on controllable process conditions.

The term “multi-layer graphene nanoplatelets,” as used herein, refers to graphene nanoplates including several sheets of graphene with an overall thickness of approximately 1-10 nanometers depending on the controllable process conditions (FIG. 4B).

The term “fluffy graphene,” as used herein, refers to a carbon-based nanomaterial having a two-dimensional graphitic sheet structure (FIG. 4C). Fluffy graphene is made up of 1 to 30 layers of graphene. The average thickness of fluffy graphene is one nanometer or less. Dimensions in plane of the carbon nanomaterials vary from hundreds of nanometers to a few microns, and are controlled by process conditions.

The term “welded multi-layer graphene-based materials (flattened flake-like or curved shell-like),” as used herein, refers to a carbon nanomaterial including a three-dimensional graphitic structure (FIG. 4D). The three-dimensional graphitic structure is made up of multi-layer graphene shells inter-connected with a common multi-layer graphene base. The shells include 1-30 layers of graphene with an average size of 3-10 nm. The average thickness of the shell is 5 nm or less. The average thickness of the base is 5 nm or less. Dimensions in plane of the graphene base vary from hundreds of nanometers to a few microns, depending on controllable process conditions.

All combinations of method or process steps as used herein can be performed in any order, unless otherwise specified or clearly implied to the contrary by the context in which the referenced combination is made.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

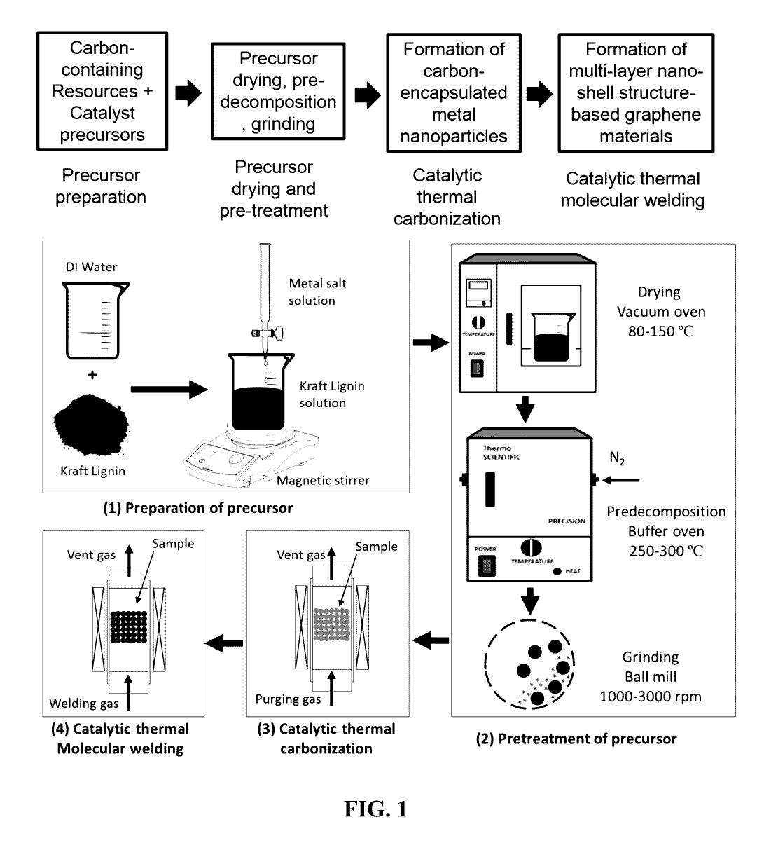

The presently-disclosed subject matter relates to processes, methods, and compositions for the catalytic thermal conversion of carbon-containing resources to graphene-based materials. In some embodiments, the processes, methods, and compositions include catalytic thermal carbonization and/or catalytic thermal molecular welding (CTMW) for synthesis of graphene-based materials from carbon-containing resources, such as biomass. Additionally or alternatively, in some embodiments, as illustrated in FIG. 1, the processes, methods, and compositions include preparation and/or pretreatment of precursors prior to catalytic thermal carbonization and/or CTMW.

The precursors include any suitable precursor for use in catalytic thermal carbonization and/or CTMW, such as catalyst-biomass precursors. In some embodiments, preparing the precursors includes an impregnation method where a biomass is mixed with a catalyst. In some embodiments, 2.5% to 30% by weight catalyst is mixed with 70% to 97.5% by weight biomass. In one embodiment, the biomass is uniformly mixed with the catalyst. In another embodiment, the biomass is depolymerized and/or dissolved in a solvent prior to mixing with the catalyst. After depolymerizing and/or dissolving the biomass in a solvent, the catalyst may be added directly to the biomass-solvent solution, or the catalyst may be separately dissolved in a solvent to form a catalyst-solvent solution, which is then added to the biomass-solvent solution. In a further embodiment, the biomass-catalyst mixture is dried, forming a catalyst-impregnated biomass precursor.

The biomass includes any suitable source of carbon for the CTMW process described herein. One suitable biomass source includes lignin, such as, but not limited to, kraft lignin, organosolv lignin, lignosulfonates, hydrolytic lignin, black liquor, lignin from kraft pulp mills, or combinations thereof. Other suitable biomass feedstocks include, but are not limited to, woody biomass and its derivatives, wood chips, wood char, wood-based chars, pyrolysis char, starch, sugar (e.g., glucose, xylose, arabinose, galactose, mannose, cellulose, hemicellulose), wood-derived sugars, mixture sugars from biomass hydrolysis, active carbon, carbon black, or combinations thereof. For example, in one embodiment, preparing the precursor includes uniformly mixing kraft lignin with a catalyst. Unlike lignosulfonates, kraft lignin does not include any sulfonate groups and therefore is only soluble in alkaline solutions (e.g., solutions having a pH of at least 10). In this embodiment, as the kraft lignin is a large complex organic polymer which is difficult for catalysts to penetrate into molecular lignin, depolymerizing and/or dissolving of the kraft lignin in a solvent facilitates the uniform mixing of the kraft lignin and the catalyst. As will be appreciated by those of ordinary skill in the art, the solvent may include any suitable solvent for depolymerizing and/or dissolving the selected biomass. Suitable solvents for kraft lignin include, but are not limited to, water, DI water, methanol, acetone, 1,3-dioxane, 1,4-dioxane, tetrahydrofuran, ethanol, a co-solvent thereof, or combinations thereof.

Suitable catalysts include, but are not limited to, metal catalysts, multi-metal catalysts (e.g., bimetallic catalyst, tri-metallic catalyst, tetra-metallic catalyst, or other multi-metal catalysts), and/or salts thereof. In some embodiments, the metal catalyst includes a transition metal, a salt thereof, an oxide thereof, and/or a combination thereof. Transitional metals are classified into three groups according to their reactivity with carbon: (i) metals in groups IB and IIB; (ii) metals in group VIII; and (iii) metals in groups IVB and VIIB. The metals in groups IB and IIB cannot react with carbon because of a completed d-electron shell. The metals in group VIII have a d shell occupied by 6 to 10 electrons and can dissolve carbon, although the energy level of such configurations is scarcely changed by accepting additional electrons from carbon (usually carbon is thought to dissolve as the positively charged ion). The metals in groups IVB and VIIB have 2 to 5 electrons in the d shell and form strong chemical bonds with carbon and yield the metal carbide. Accordingly, in one embodiment, at least one of Fe, Cu, Ni, Co, Mo, W, a salt thereof, an oxide thereof, and/or a combination thereof is selected as the transition metal for the metal catalyst. Active catalyst components, single metal, bimetallic, as well as tertiary combinations of these metals are examined in the Examples below on the formation of graphene-based materials from kraft lignin.

Additionally or alternatively, the catalytic properties of metal catalysts may be affected by various factors such as catalyst preparation method, metal precursor identity, and toxic elements (usually halogen, sulfur, and phosphorus) in the reactants. For example, the catalytic properties differ between various iron metal precursors, such as iron (III) nitrate, iron sulfate, iron (II) chloride (FeCl₂), iron (III) chloride (FeCl₃), iron oxides, and iron powder, as illustrated in the Examples below. In particular, the process for preparation of the precursors with different types of solvents, different loadings of transition metals, different types of transition metals, and different lignin sources are illustrated below in examples 1-34.

Another condition which affects the production of graphene-based materials from biomass includes the amount of feedstock relative to the amount of catalyst used. For example, in one embodiment, the mass ratio of kraft lignin to the metal catalyst includes between 5:1 and 20:1. While this range of mass ratios is examined in the Examples below, those of ordinary skill in the art will understand that the mass ratio of kraft lignin to metal catalyst is not so limited, and ratios outside of this range are also contemplated herein. Additionally, as will be appreciated by those of ordinary skill in the art, the amounts of feedstock and catalyst may vary depending upon the particular feedstock and/or catalyst being used, and therefore ratios of other biomass sources to metal catalysts within and outside this range are contemplated herein. Other suitable mass ratio ranges of biomass to metal catalyst include, but are not limited to, between about 30:1 to about 1:30, between about 30:1 to about 1:1, between about 1:1 to about 1:30, between about 20:1 to about 1:1, between about 1:1 to about 1:20, between about 10:1 to about 1:1, between about 1:1 to about 1:10, or any suitable combination, sub-combination, range, or sub-range thereof.

As discussed above, in some embodiments, the processes, methods, and compositions disclosed herein include pretreatment of precursors prior to catalytic thermal carbonization and/or CTMW. In one embodiment, pretreatment of the precursors includes thermal treatment. In another embodiment, the thermal treatment includes pre-decomposition of the precursor. In a further embodiment, the thermal treatment includes a temperature of at least 200° C., at least 250° C., at least 300° C., between 200° C. and 300° C., between 250° C. and 300° C., or any combination, sub-combination, range, or sub-range thereof. As will be appreciated by those of ordinary skill in the art, the thermal treatment temperature may vary depending upon the biomass source and/or the thermal degradation temperature thereof. For example, the thermal degradation of kraft lignin starts at 200° C., which corresponds to β-O-4 bond breaking. Accordingly, in certain embodiments, pretreatment includes pre-decomposition of the precursor at 300° C. before loading it into the reactor system.

Additionally or alternatively, the pretreatment may include grinding the precursor. Without wishing to be bound by theory, it is believed that the cleavage of the aryl-ether linkages results in the formation of highly reactive radicals that may further interact and form a highly condensed crosslinking structure which sticks to the catalyst. As long as the catalyst is trapped in the condensed carbon, the catalyst particles are prevented from contacting carbonaceous gases. This can lead to the graphene growth being stopped, which can lower graphene yield and selectivity. Therefore, in certain embodiments, grinding of the precursor into a powder increases the yield and/or selectivity of graphene materials formed according to one or more of the methods disclosed herein.

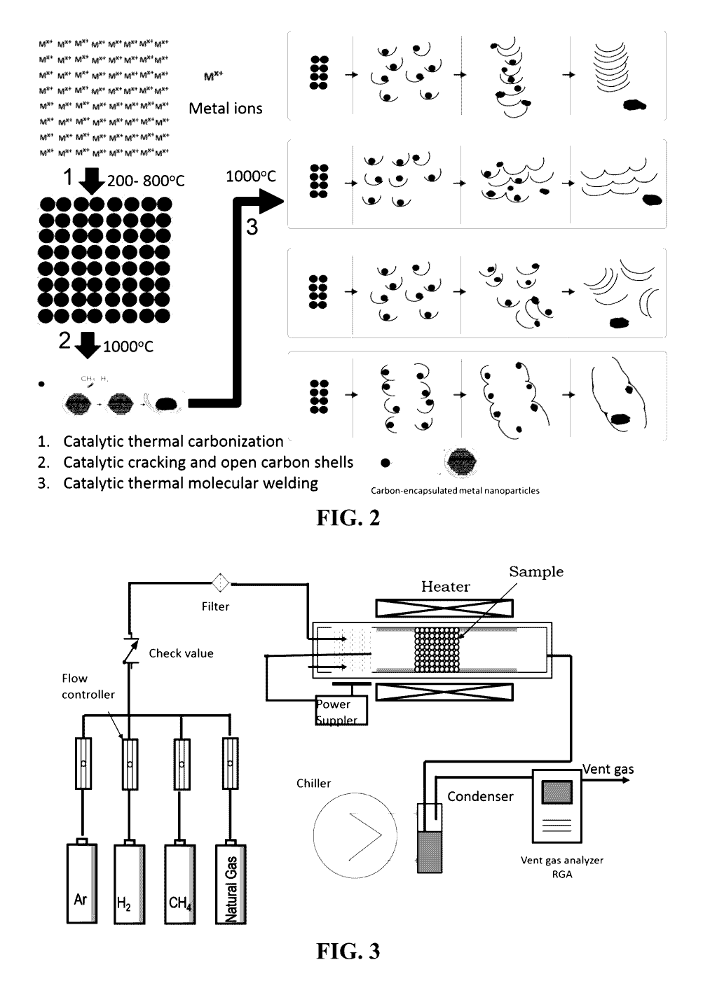

In some embodiments, the CTMW process (FIG. 2) includes a single step process with two stages. In one embodiment, the CTMW process is performed over a fixed bed reaction system (FIG. 3). In another embodiment, the first stage includes formation of carbon-encapsulated transitional metal structures by thermal treatment of transitional metal-promoted biomass-based precursors. The carbon-encapsulated transitional metal structures include any suitable carbon-encapsulated transitional metal structures, such as, but not limited to, carbon-encapsulated metal nanoparticles, multi-layer graphene-encapsulated transitional metal structures, or a combination thereof. In a further embodiment, the second stage includes cracking and/or opening of the carbon-encapsulated transitional metal structures to form shell-like structures, followed by welding and reconstruction of the shell-like structures to form the graphene-based materials.

In certain embodiments, the welding and/or reconstruction of the shell-like structures includes the use and/or application of welding reagent gases. Suitable welding gases include, but are not limited to, light hydrocarbons (e.g., methane (CH₄), ethane (C₂H₆), propane (C₃H₈), natural gas (NG), etc.), argon (Ar), hydrogen (H₂), natural gas, other carbonaceous gases, and/or combinations thereof. These welding gases are provided at any suitable flow rate, such as, but not limited to, between 20 and 300 mL/min. Without wishing to be bound by theory, it is believed that the welding gases provide at least four (4) different functions in the CTMW process. In one embodiment, the first function includes “gluing” the nano-size multi-layer graphene shell structures (or building blocks) from biomass, such as kraft lignin. In another embodiment, the second function includes reacting (gasifying) amorphous carbon biomass precursors to carbonaceous gases followed by re-deposition to form graphene materials. In a further embodiment, the third function includes healing the defect of the graphene materials formed from lignin. In still a further embodiment, the fourth function includes part of the welding molecules serving directly as a reactant to form carbon nano-structures (e.g., carbon nanotubes, graphene).

Additionally or alternatively, the welding and/or reconstruction may be performed under high temperature. For example, in one embodiment, the welding temperature is at least 500° C., at least 600° C., between 500° C. and 1,500° C., between 600° C. and 1,500° C., between 800° C. and 1,500° C., between 800° C. and 1,100° C., or any combination, sub-combination, range, or sub-range thereof. In another embodiment, the welding and/or reconstruction includes heating rates ranging from 2.5 to 30° C./min, including 2.5° C., 5.0° C., 10° C., 20° C., and 30° C./min. In a further embodiment, heating time is at least 0.5 hours, up to 5 hours, up to 4 hours, between 0.5 hours and 5 hours, between 0.5 hours and 4 hours, between 0.5 hours and 3 hours, about 2 hours, about 1 hour, or any combination, sub-combination, range, or sub-range thereof.

In some embodiments, following the heating process, the methods can further include purifying or post-treating the mixture to remove inorganic ash from the products. In some embodiments this purifying step can occur following heating and/or cooling of the graphene material. Post treatment may include the addition of nitrogen, sulfur, or other suitable elements or chemicals to the graphene materials to alter the materials' properties. The purification of the cooled mixture can be achieved through water treatment, carbon dioxide treatment, steam treatment, hydrogen sulfide treatment, carbon disulfide treatment, ammonia treatment, basic solution treatment, acid purification, combinations thereof, and the like. This includes water and/or acid purification methods that are currently known in the art. In some embodiments the purification process includes exposing synthesized graphene materials to water and/or acid, and optionally boiling the graphene materials in water and/or acid. In some embodiments graphene materials can further be filtered and/or rinsed one or more times to purify the synthesized graphene materials. The purification may also be used to remove remaining catalyst metal particles from the graphene materials. In some embodiments, the purification may include washing the graphene products with an acid solution, a basic solution, or ammonia.

In contrast to existing physical welding processes, which mainly produce nano-structured materials with low yield and selectivity, the CTMW process disclosed herein facilitates selective production of graphene materials from biomass feedstock with high yield. Suitable graphene-based materials formed according to one or more of the methods disclosed herein include single or multi-layer graphene-based materials, such as, but not limited to, graphene, graphene-encapsulated metal, and/or metal carbide nanoparticles. In one embodiment, the single or multi-layer graphene-based materials include nano-shell structure-based graphene materials. In another embodiment, the multi-layer nano-shell structure-based graphene materials include, but are not limited to, nano-graphene shell connected chains (FIG. 4A), graphene nanoplatelets (FIG. 4B), fluffy graphene (FIG. 4C), flat and/or curved graphene sheets (FIG. 4D), graphene sponges, graphene-encapsulated metal, metal carbide nanoparticles, graphene strips with a common metal joint, or combinations thereof.

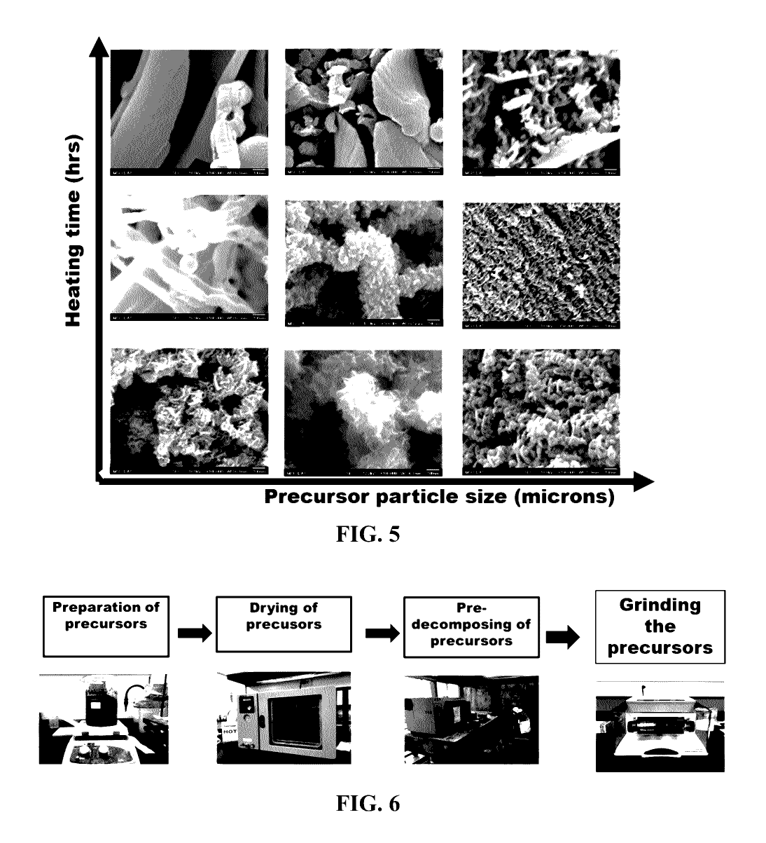

The different multi-layer nano-shell structure-based graphene material forms may be produced through altering one or more fabrication conditions. For example, in one embodiment, different transitional metal catalysts (e.g., Ni, Cu, Fe, Co, Mo, W) may be used to vary the yields and/or structures of the graphene materials. The effects of certain transition metals are discussed in detail in Examples 12-14 and 57-61 below. In another embodiment, different iron chemical resources (e.g., Fe(NO₃)₃, FeCl₂, FeC1₃, Fe₂O₃ (nano), Fe₂O₃ (micron), iron powder (micron)) and/or iron loading may be used to vary the yields and/or structures of the graphene materials. The effects of iron loading on graphene material yield are discussed in detail in Examples 51-56 below. In a further embodiment, temperature, heating rate, heating time, metal-lignin precursor particle size, welding reagent gas type, and/or flow rate may be changed to vary the yields and/or structures of the graphene materials. The effects of these conditions on graphene production are discussed in detail in Examples 66-92 below, including Examples 88-92, which examine the effect of precursor particle size between 20 and 500 microns (μm) on final products (FIG. 5).

As will be appreciated by those of ordinary skill in the art, the fabrication conditions which may be altered to produce different graphene materials are not limited to those discussed above, and may include any other condition that effects graphene material yield and/or structure, such as biomass source. The effects of lignin sources on precursor and graphene production is compared in Examples 26-28, 45, and 93-95 below. The use of other biomass feedstocks in production of graphene materials is illustrated in Examples 34-35 below.

### EXAMPLES

The presently-disclosed subject matter is further illustrated by the following specific but non-limiting examples. The following examples may include compilations of data that are representative of data gathered at various times during the course of development and experimentation related to the presently-disclosed subject matter.

### Examples 1-5

Examples 1-5 illustrate the effects of different solvents on precursor preparation.

### Example 1

Iron promoted lignin precursor was prepared using an impregnation method. 300 grams of kraft lignin (provided by Domtar) was first added to 300 mL de-ionized (DI) water in a 2000 mL glass beaker and stirred for 2 hours to obtain a lignin-water mixture. The iron nitrate-water mixture was obtained through adding 246.0 grams of iron (III) nitrate nonahydrate from Sigma-Aldrich to 100 mL DI water in a 500 mL glass beaker and stirring until iron nitrate was dissolved completely. The iron nitrate solution was added drop-like (˜2 mL/min) to the lignin-water mixture and stirred for 2 hours. The final mixture was kept at room temperature for 24 h and then oven-dried at 110° C. for one day (12-24 hours).

### Example 2

300 grams of kraft lignin (provided by Domtar) was first added to 300 mL ethanol in a 2000 mL glass beaker and stirred for 2 hours to obtain the lignin-ethanol mixture. 246.0 grams of iron (III) nitrate nonahydrate from Sigma-Aldrich was added to 100 mL DI water in a 500 mL glass beaker, followed by stirring the mixture until iron nitrate was dissolved completely. The iron nitrate solution was added drop-like (˜2 mL/min) to the lignin-ethanol mixture and the iron nitrate-lignin-ethanol mixture was stirred for 2 hours. The final mixture was kept at room temperature for 24 h and then oven-dried at 110° C. for one day.

### Example 3

300 grams of kraft lignin (provided by Domtar) was first added to 300 mL acetone in a 2000 mL glass beaker and the lignin-acetone mixture was stirred for 2 hours. 246.0 grams of iron (III) nitrate nonahydrate from Sigma-Aldrich was added to 100 mL DI water in a 500 mL glass beaker and the iron nitrate-water mixture was stirred until iron nitrate was dissolved completely. The iron nitrate solution was added drop-like (˜2 mL/min) to the lignin-acetone mixture and the final lignin-acetone-iron nitrate mixture was stirred for 2 hours. The final mixture was kept at room temperature for 24 h and then oven-dried at 110° C. for one day.

### Example 4

300 grams of kraft lignin (provided by Domtar) was first added to 300 mL 1,3-Dioxane in a 2000 mL glass beaker and the lignin-1,3-Dioxane mixture was stirred for 2 hours. 246.0 grams of iron (III) nitrate nonahydrate from Sigma-Aldrich was added to 100 mL DI water in a 500 mL glass beaker and the iron nitrate-water mixture was stirred until iron nitrate was dissolved completely. The iron nitrate solution was added drop-like (˜2 mL/min) to the lignin-1,3-Dioxane mixture and the final lignin-1,3-Dioxane-iron nitrate mixture was stirred for 2 hours. The final mixture was kept at room temperature for 24 h and then oven-dried at 110° C. for one day.

### Example 5

300 grams of kraft lignin (provided by Domtar) was first added to 300 mL tetrahydrofuran in a 2000 mL glass beaker and the lignin-tetrahydrofuran mixture was stirred for 2 hours. 246.0 grams of iron (III) nitrate nonahydrate was added to 100 mL DI water in a 500 mL glass beaker and the iron nitrate-water mixture was stirred until iron nitrate was dissolved completely. The iron nitrate solution was added drop-like (˜2 mL/min) to the lignin-tetrahydrofuran mixture and the resulting mixture was stirred for 2 hours. The final mixture was kept at room temperature for 24 h and then oven-dried at 110° C. for one day.

### Examples 6-11

Examples 6-11 show the effects of different loading of transition metals on precursor preparation.

Six loadings of iron (III) nitrate nonahydrate, 20.5 g, 38.9 g, 59.9 g, 105.5 g, 130.4 g and 184.7 g were added to each of six volume levels of DI water 12.5 mL, 25 mL, 37.5 mL, 62.5 mL, 75 mL and 100 mL held in a 500 mL glass beaker, respectively, and all 6 mixtures were stirred for 30 minutes. Each of these six iron nitrate solutions were added drop-like (˜2mL/min) to its respective tetrahydrofuran kraft lignin solution (100 g lignin in 100 mL tetrahydrofuran) and the final mixtures are all stirred for 2 hours. The six samples are labeled as Examples 6-11.

### Examples 12-24

Examples 12-24 illustrate the effect of different types of transition metals on precursor preparation.

### Example 12

Nickel promoted lignin precursor is prepared using an impregnation method. 100 grams of kraft lignin (provided by Domtar) is first added to 100 mL tetrahydrofuran in a 2000 mL glass beaker and the lignin-tetrahydrofuran solution is stirred for 2 hours. 56.2 grams of nickel nitrate hexahydrate [Ni(NO₃)₂·6H₂O from Sigma-Aldrich] are added to 50 mL DI water in a 500 mL glass beaker, and nickel nitrate-water mixture is stirred for 30 minutes. The nickel nitrate solution drop-like (˜2 mL/min) is added to lignin-tetrahydrofuran solution. The final lignin-tetrahydrofuran-nickel nitrate mixture is stirred for 2 hours, followed by keeping the mixture at room temperature for 24 h, and then oven-drying it at 110° C. for one day.

### Example 13

Copper promoted lignin precursor is prepared using an impregnation method. 100 grams of kraft lignin (provided by Domtar) is first added to 100 mL tetrahydrofuran in a 2000 mL glass beaker and the lignin-tetrahydrofuran solution is stirred for 2 hours. 42.7 grams of copper nitrate tetrahydrate (Cu(NO₃)₂·4H₂O from Sigma-Aldrich) are added to 50 mL DI water in a 500 mL glass beaker, and copper nitrate-water mixture is stirred for 30 minutes. The copper nitrate solution drop-like (˜2 mL/min) is added to lignin-tetrahydrofuran solution. The final lignin-tetrahydrofuran-copper nitrate mixture is stirred for 2 hours, followed by keeping the mixture at room temperature for 24 h, and then oven-drying it at 110° C. for one day.

### Example 14

Cobalt promoted lignin precursor is prepared using an impregnation method. 100 grams of kraft lignin (provided by Domtar) is first added to 100 mL tetrahydrofuran in a 2000 mL glass beaker and the lignin-tetrahydrofuran mixture is stirred for 2 hours. 42.7 grams of cobalt nitrate hexahydrate (Co(NO₃)₂·6H₂O from Sigma-Aldrich) are added to 50 mL DI water in a 500 mL glass beaker, and the cobalt nitrate solution is stirred for 30 minutes. The cobalt nitrate solution drop-like (˜2 mL/min) is added to the lignin-tetrahydrofuran solution. The final lignin-tetrahydrofuran-cobalt nitrate mixture is stirred for 2 hours, followed by keeping the mixture at room temperature for 24 h, and then oven-drying it at 110° C. for one day.

### Example 15

Molybdenum promoted lignin precursor is prepared using an impregnation method. 100 grams of kraft lignin (provided by Domtar) is first added to 100 mL tetrahydrofuran in a 2000 mL glass beaker, and the lignin-tetrahydrofuran mixture is stirred for 2 hours. 46.4 grams of ammonium molybdate tetrahydrate ((NH₄)₆Mo₇O₂₄·4H₂O from Sigma-Aldrich) are added to 100 mL DI water in a 500 mL glass beaker, and the ammonium molybdate solution is stirred for 30 minutes. The ammonium molybdate solution drop-like (˜2 mL/min) is added to lignin-tetrahydrofuran solution. The final mixture is stirred for 2 hours, followed by keeping the mixture at room temperature for 24 h, and then oven-drying it at 110° C. for one day.

### Example 16

Tungsten promoted lignin precursor is prepared using an impregnation method. 100 grams of kraft lignin (provided by Domtar) is first added to 100 mL tetrahydrofuran in a 2000 mL glass beaker, and the lignin-tetrahydrofuran mixture is stirred for 2 hours. 32.4 grams of ammonium metatungstate hydrate ((NH₄)₆H₂W₁₂O₄₀·xH₂O from Sigma-Aldrich) are added to 100 mL DI water in a 500 mL glass beaker, and ammonium metatungstate solution is stirred for 30 minutes. The ammonium metatungstate solution drop-like (˜2 mL/min) is added to lignin-tetrahydrofuran solution. The final mixture is stirred for 2 hours, followed by keeping the mixture at room temperature for 24 h, and then oven-drying it at 110° C. for one day.

### Example 17

300 grams of kraft lignin (provided by Domtar) is first added to 300 mL tetrahydrofuran in a 2000 mL glass beaker, and the lignin-tetrahydrofuran mixture is stirred for 2 hours. 246.0 grams of Iron (III) nitrate nonahydrate and 21.4 grams of copper nitrate tetrahydrate (Cu(NO₃)₂·4H₂O are added to 100 mL DI water in a 500 mL glass beaker, and the mixture is stirred until all solids dissolve completely. The Iron and copper nitrates solution drop-like (˜2 mL/min) is added to lignin-tetrahydrofuran solution. The final mixture is stirred for 2 hours, followed by keeping the mixture at room temperature for 24 h, and then oven-drying it at 110° C. for one day.

### Example 18

300 grams of kraft lignin (provided by Domtar) is first added to 300 mL tetrahydrofuran in a 2000mL glass beaker, and the lignin-tetrahydrofuran mixture is stirred for 2 hours. 246.0 grams of Iron (III) nitrate nonahydrate and 18.7 grams of nickel nitrate hexahydrate are added to 150 mL DI water in a 500 mL glass beaker and the mixture is stirred until all solids dissolve completely. The Iron-nickel nitrates solution drop-like (˜2 mL/min) is added to the lignin-tetrahydrofuran solution. The final mixture is stirred for 2 hours, followed by keeping the mixture at room temperature for 24 h, and then oven-drying it at 110° C. for one day.

### Example 19

300 grams of kraft lignin (provided by Domtar) is first added to 300 mL tetrahydrofuran in a 2000 mL glass beaker, and the lignin-tetrahydrofuran mixture is stirred for 2 hours. 246.0 grams of Iron (III) nitrate nonahydrate and 23.2 grams of ammonium molybdate tetrahydrate are added to 150 mL DI water in a 500 mL glass beaker and the mixture is stirred until all solids dissolve completely. The metal salt solution drop-like (˜2 mL/min) is added to lignin-tetrahydrofuran solution. The final mixture is stirred for 2 hours, followed by keeping the mixture at room temperature for 24 h, and then oven-drying it at 110° C. for one day.

### Example 20

300 grams of kraft lignin (provided by Domtar) is first added to 300 mL tetrahydrofuran in a 2000 mL glass beaker, and the lignin-tetrahydrofuran mixture is stirred for 2 hours. 246.0 grams of Iron (III) nitrate nonahydrate, 21.4 grams of copper nitrate, and 23.2 grams of ammonium molybdate tetrahydrate are added to 150 mL DI water in a 500 mL glass beaker and the mixture is stirred until all solids dissolved completely. The metal salt solution drop-like (˜2 mL/min) is added to lignin-tetrahydrofuran solution. The final mixture is stirred for 2 hours, followed by keeping the mixture at room temperature for 24 h, and then oven-drying it at 110° C. for one day.

### Example 21

100 grams of kraft lignin (provided by Domtar) is first added to 100 mL tetrahydrofuran in a 2000 mL glass beaker, and the lignin-tetrahydrofuran mixture is stirred for 2 hours. 32.9 grams of iron (III) chloride (FeCl₃, from Sigma-Aldrich) is added to 100 mL DI water in a 500 mL glass beaker and the mixture is stirred for 30 minutes. The Iron (III) chloride solution drop-like (˜2 mL/min) is added to the lignin-tetrahydrofuran solution. The final mixture is stirred for 2 hours, followed by keeping the mixture at room temperature for 24 h, and then oven-drying it at 110° C. for one day.

### Example 22

100 grams of kraft lignin (provided by Domtar) is first added to 100 mL tetrahydrofuran in a 2000 mL glass beaker, and the lignin-tetrahydrofuran mixture is stirred for 2 hours. 40.0 grams of iron (II) chloride tetrahydrate (FeCl₂·4H₂O) from Sigma-Aldrich) is added to 100 mL DI water in a 500 mL glass beaker, and the mixture is stirred for 30 minutes. The iron (II) chloride solution drop-like (˜2 mL/min) is added to the lignin-tetrahydrofuran solution. The final mixture is stirred for 2 hours, followed by keeping the mixture at room temperature for 24 h, and then oven-drying it at 110° C. for one day.

### Example 23

300 grams of kraft lignin (provided by Domtar) is mixed with 48.3 grams Iron (III) oxide (from Sigma-Aldrich, powder, <5 μm, ≧99%). The mixture is grounded in a ball mill machine (Planetary Ball Mill) with 1000 rpm for 2 hours.

### Example 24

300 grams of kraft lignin (provided by Domtar) is mixed with 33.3 grams Iron powder (from Sigma-Aldrich, powder, <10 μm, ≧99.9%). The mixture is grounded in a ball mill machine (Planetary Ball Mill) with 1000 rpm for 2 hours.

### Example 25

300 grams of kraft lignin (provided by Domtar) is mixed with 48.3 grams Iron oxides nanoparticles (˜25 nm, ≧99.9%). The mixture is grounded in a ball mill machine (Planetary Ball Mill) with 1000 rpm for 2 hours.

### Examples 26-28

Examples 26-28 illustrate the effects of different lignin sources on precursor preparation.

Different lignin sources, alkali lignin, organsolv lignin, and lignosulfonates (all from Sigma-Aldrich) are used to prepare the precursors. 300 grams of each of three lignin samples (Sigma-Aldrich) are first added to 300 mL tetrahydrofuran in a 2000 mL glass beaker, and the lignin-tetrahydrofuran is stirred for 2 hours. 246.0 grams of Iron (III) nitrate nonahydrate is added to 100 mL DI water in a 500 mL glass beaker and the mixture is stirred until all solids dissolve completely. This preparation of iron nitrate solution repeats three times. The prepared three sets of Iron nitrate solutions drop-like (˜2 mL/min) are added to each of three lignin-tetrahydrofuran solutions, respectively. These three final mixtures are stirred for 2 hours, respectively, followed by keeping each of three mixtures at room temperature for 24 h, and then oven drying them at 110° C. for one day.

TABLE 1
Precursors using different lignin sources.

| Precursor sample | Lignin Sources |
|---|---|
| Example 26 | Alkali lignin (Sigma-Aldrich) |
| Example 27 | Organsolv lignin (Sigma-Aldrich) |
| Example 28 | LS lignin (Sigma-Aldrich) |

### Examples 29-33

Examples 29-33 illustrate preparation of precursors with black liquor.

### Example 29

246.0 grams of Iron (III) nitrate nonahydrate are added to 100 mL DI water in a 500 mL glass beaker, and the mixture is stirred until solid dissolves completely, followed by adding the Iron nitrate solution drop-like (˜2 mL/min) to black liquor from kraft pulp mills which contains about 300 grams of kraft lignin, and stirring the iron nitrate-black liquor mixture for 1 hours. The final mixture is kept at room temperature for 24 h, and then filtered., followed by washing the solid with DI water for 3 times, and then oven-drying the washed solid at 110° C. for one day.

### Example 30

246.0 grams of Iron (III) nitrate nonahydrate and 21.4 grams of copper nitrate tetrahydrate [Cu (NO₃)₂·4H₂O] are added to 100 mL DI water in a 500 mL glass beaker, and the mixture is stirred until all solids dissolve completely, followed by adding the Iron and copper nitrate solution drop-like (˜2 mL/min) to black liquor from kraft pulp mills which contains about 300 grams of kraft lignin, and stirring the iron-copper nitrate-black liquor mixture for 1 hours. The final mixture is kept at room temperature for 24 h and then filtered, followed by washing the solid with DI water for 3 times, and then oven-drying the washed solid at 110° C. for one day.

### Example 31

33.3 grams Iron powder is added black liquor from kraft pulp mills which contains about 300 grams of kraft lignin, and the iron powder-black liquor mixture is stirred for 30 minutes. 21.4 grams of copper nitrate tetrahydrate [Cu(NO₃)₂·4H₂O] is added to 50 mL DI water in a 500 mL glass beaker, and the copper nitrate mixture is stirred until the solid dissolves completely. Then copper nitrate solution is added drop-like (˜2 mL/min) to the iron powder-black liquor mixture and the mixture is stirred for 1 hours. The final mixture is dried at 110° C. for one day, followed by grinding the dried mixture in a ball mill machine with 1000 rpm for 2 hours.

### Example 32

33.3 grams Iron powder is added the black liquor from kraft pulp mills, which contains about 300 grams of kraft lignin, and the iron-black liquor mixture is stirred for 1 hours. The final mixture is dried at 110° C. for one day, followed by grinding the dried mixture in a ball mill machine with 1000 rpm for 2 hours.

### Example 33

10.7 g of copper nitrate is dissolved in 20 mL DI water, stirred for 30 minutes, then 33.3 grams Iron powder is added to the copper nitrate solution, stirring for 30 minutes. The mixture is kept at room temperature for 24 h, and then transferred to an oven where it is dried at 150° C. for one day. The dried Cu—Fe powder is grounded in a ball mill machine for 30 minutes. Followed by adding the Cu—Fe powder to a black liquor from kraft pulp mills which contains about 300 grams of kraft lignin, stirring for 1 hours. The mixture is dried at 110° C. for one day. The dried mixture is grounded in a ball mill machine for 2 hours.

### Examples 34-35

Examples 34-35 illustrate preparation of precursors with other biomass feedstocks.

### Example 34

246.0 grams of Iron (III) nitrate nonahydrate from Sigma-Aldrich is added to 100 mL DI water in a 500 mL glass beaker and the iron nitrate mixture is stirred until the solid dissolves completely. The Iron nitrate solution drop-like (·2 mL/min) is added to 100 g wood char, followed by stirring the mixture for 0.5 hours. Wood char is obtained from a typical fast pyrolysis process. The iron-char mixture is kept at room temperature for 24 h, and then oven-dried at 110° C. for one day.

### Example 35

Fifty grams of Iron (III) nitrate nonahydrate from Sigma-Aldrich dissolve in 1000 mL DI water, followed by adding 100 grams of sugar, which are selected from glucose, xylose, arabinose, galactose, mannose, cellulose, hemicellulose, starch or mixture sugars from biomass hydrolysis process, to the iron (III) nitrate solution. The iron nitrate-sugar mixture is stirred for 0.5 hours and then transferred into a five-liter Parr reactor in which the mixture is heated at the temperature maintained at 160 to 180° C. for 8 hrs. After the reaction, a black product is collected and washed three times with DI water. The final washed product is oven-dried at 110° C. for 12 h.

### Examples 36-40

Examples 36-40 illustrate pretreatment of precursors.

One hundred fifty grams (150g) of the iron-impregnated kraft lignin sample from each of Examples 1-5 is thermally treated using a muffle furnace (FIG. 6). The inert carrier gas—either argon or nitrogen is first introduced into the furnace at a flow rate of 80 mL/min for 30 minutes. The furnace is temperature-programmed with a rate of 2.5° C./min to 300° C. and kept at 300° C. for 2 hours. The furnace is turned off and the samples are allowed to cool to ambient temperature naturally. Then the cooled sample is loaded into a ball mill machine and grounded in 1000 rpm for 30 minutes. Each of the pretreated samples is labeled as Example 36, Example 37, Example 38, Example 39, and Example 40, respectively.

TABLE 2
Pretreated samples from Examples 1-5.

| Sample | Precursor | Purging gas | Flow rate (mL/min) |
|---|---|---|---|
| Example 36 | Example 1 | Argon/Nitrogen | 80 |
| Example 37 | Example 2 | Argon/Nitrogen | 80 |
| Example 38 | Example 3 | Argon/Nitrogen | 80 |
| Example 39 | Example 4 | Argon/Nitrogen | 80 |
| Example 40 | Example 5 | Argon/Nitrogen | 80 |

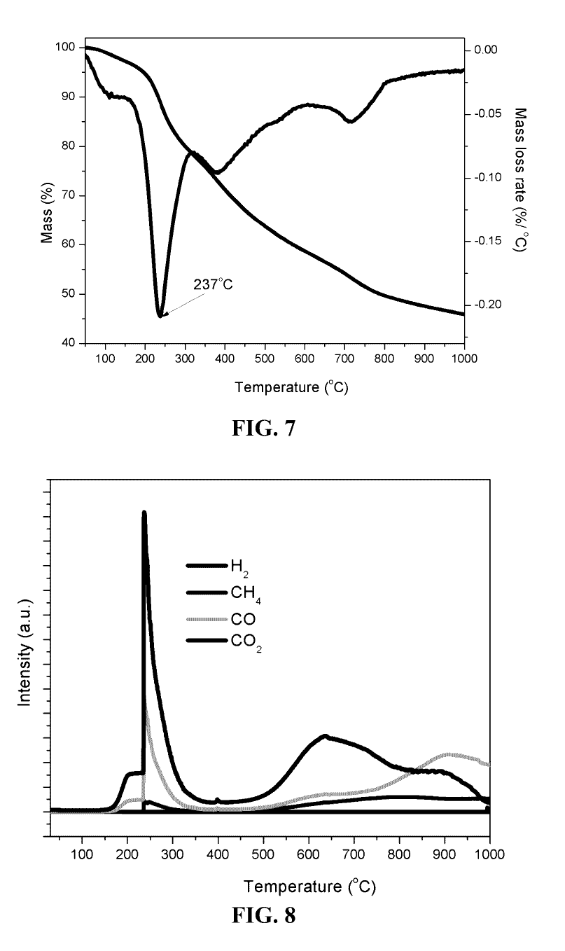

Fresh dried precursors were examined by thermal gravimetric analysis (TGA) and temperature-programmed decomposition (TPD) (FIGS. 7 and 8). The significant mass loss was observed around 190 to 300° C. and was mainly due to CO₂ release. The calculation suggests that the pressurization rate at 237° C. in the existing thermal treatment system (2-inch O.D. ceramic tube with a 26-inch length) is 294 psi/min. Scaling up the manufacturing process may cause a pressurization rate increase to 500 psi/min at the temperature zone between 190 to 300° C. This type of pressure increase may breakdown a reactor system. Accordingly, in certain embodiments, the catalyst-lignin precursors are pre-decomposed for safety operation before loading into the reactor. According to the TGA and TPD results, the desired pre-decomposition temperature is set between 250 to 300° C.

### Examples 41-50

Examples 41-50 illustrate the effects of solvent types on graphene material production yield.

Fifty grams (50 g) of the iron-impregnated kraft lignin sample from each of Examples 1-5 and Examples 36-40 is packed in the middle of a 2-inch OD ceramic tubular reactor (FIG. 3). The welding gas of 50 mL/min argon and 80 mL/min CH₄ is first introduced into the reactor for 30 minutes. The reactor is temperature-programmed with a heating rate of 30° C./min to 1000° C. and kept at 1000° C. for 1 hour under the welding flow gases. The furnace is cooled down by a rate of 10° C./min to room temperature under a flow of 50 mL/min argon. Each of the reacted samples is labeled as Examples 41-50, respectively.

TABLE 3
Effects of different solvents on graphene nanomaterial
production at the temperature of 1000° C. for 1 hour.

| | | | Graphene |
|---|---|---|---|
| Example | Precursor | Solvents | nanomaterial yield (%) |
| Example 41 | Example 1 | Water | 52.3 ± 1.0 |
| Example 42 | Example 2 | Ethanol | 53.7 ± 0.8 |
| Example 43 | Example 3 | Acetone | 54.3 ± 0.7 |
| Example 44 | Example 4 | 1,3-Dioxane | 54.5 ± 0.7 |
| Example 45 | Example 5 | Tetrahydrofuran | 55.1 ± 0.5 |
| Example 46 | Example 36 | Water | 72.2 ± 0.5 |
| Example 47 | Example 37 | Ethanol | 73.5 ± 0.6 |
| Example 48 | Example 38 | Acetone | 74.1 ± 0.5 |
| Example 49 | Example 39 | 1,3-Dioxane | 74.5 ± 0.5 |
| Example 50 | Example 40 | Tetrahydrofuran | 75.3 ± 0.4 |

### Examples 51-56

Examples 51-56 illustrate the effects of iron loading on graphene material production yield.

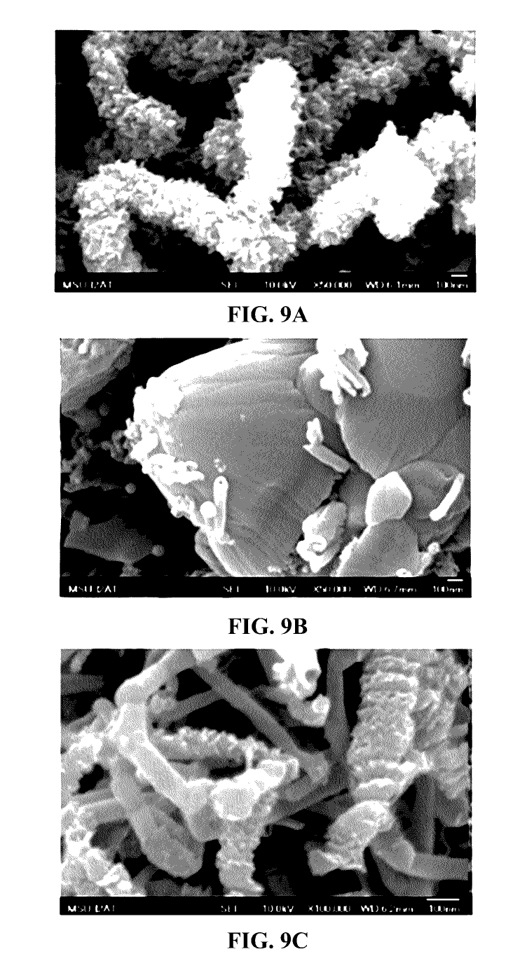

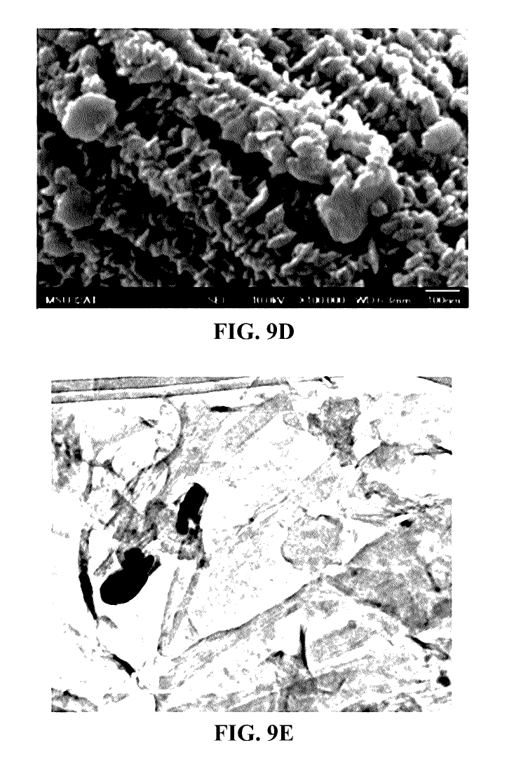

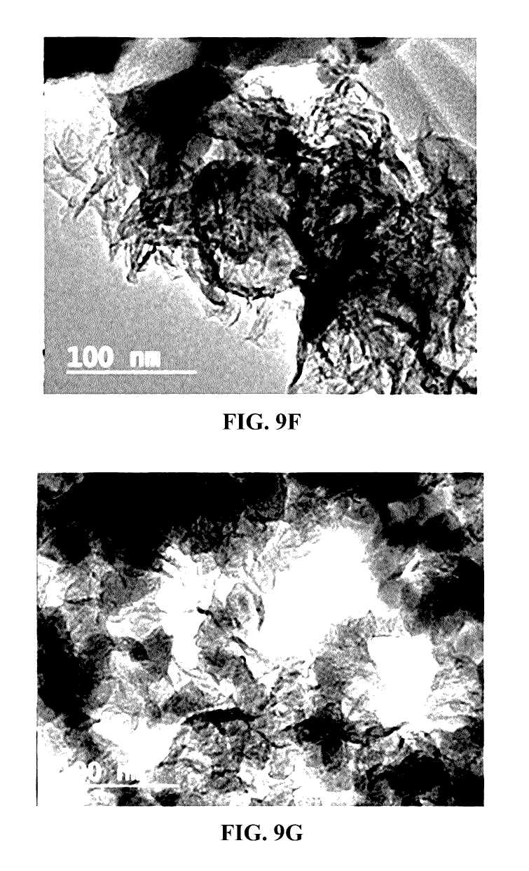

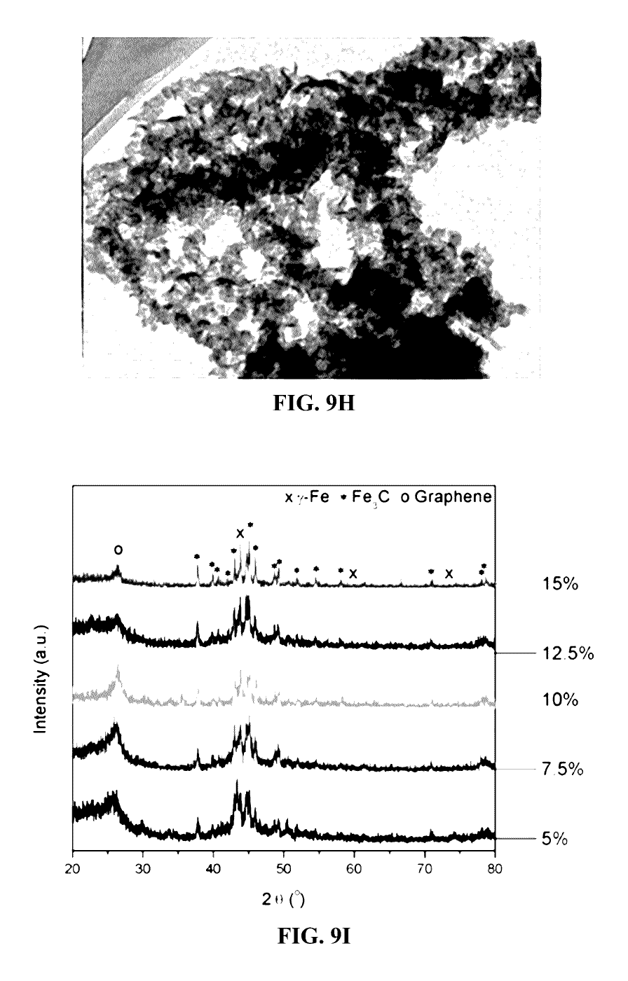

Fifty grams (50 g) of the iron-impregnated kraft lignin sample from each of Examples 6-11 is packed in the middle of a 2-inch OD ceramic tubular reactor. The carrier gas—argon (99.9% purity) is first introduced into the reactor at a flow rate of 50 mL/min for 30 minutes. The reactor is temperature-programmed with a heating rate of 2.5° C./min to 300° C. and kept at 300° C. for 30 minutes. The furnace is then continually heated up by 30° C./min to 1000° C. with the welding gas of 50 mL/min argon and 80 mL/min and kept at 1000° C. for 1 hour under the welding flow gases. The furnace is cooled down by 10° C./min to room temperature under a flow of 50 mL/min argon. Each of the reacted samples is labeled as Examples 51-56, respectively. FIGS. 9A-I demonstrate X-ray diffraction (XRD), scanning electron microscopy (SEM), and transmission electron microscopy (TEM) results of the products with different iron loading. In particular, FIGS. 9A-D illustrate SEM images of products with iron loading of 7.5% (FIG. 9A), 5% (FIG. 9B), 10% (FIG. 9C), and 12.5% (FIG. 9D); FIGS. 9E-H illustrate TEM images of products with iron loading of 5% (FIG. 9E), 7.5% (FIG. 9F), 10% (FIG. 9G), and 12.5% (FIG. 9H); and FIG. 9I illustrates an XRD plot of the different iron loading conditions.

TABLE 4
Effects of iron loading on graphene nanomaterial production
at the temperature of 1000° C. for 1 hour.

| | | | Graphene |
|---|---|---|---|
| Example | Precursor | Iron loading (%) | nanomaterial yield (%) |
| Example 51 | Example 6 | 2.5 | 57.0 ± 1.0 |
| Example 52 | Example 7 | 7.5 | 55.7 ± 0.7 |
| Example 53 | Example 8 | 12.5 | 55.3 ± 0.6 |
| Example 54 | Example 9 | 15 | 55.2 ± 0.7 |
| Example 55 | Example 10 | 15 | 55.2 ± 0.6 |
| Example 56 | Example 11 | 20 | 54.7 ± 0.8 |

### Examples 57-61

Examples 57-61 illustrate the effects of transitional metals on graphene nanomaterial production.

Fifty grams (50 g) of the sample from each of Examples 12-16 are packed in the middle of a 2-inch OD ceramic tubular reactor. The carrier gas—argon (99.9% purity), is first introduced into the reactor at a flow rate of 50 mL/min for 30 minutes. The reactor is temperature-programmed with a heating rate of 2.5° C./min to 300° C. and kept at 300° C. for 30 minutes. The furnace is then continually heated up by 30° C./min to 1000° C. with the welding gas of 50 mL/min argon and 80 mL/min and kept at 1000° C. for 1 hour under the welding flow gases. The furnace is cooled down by 10° C./min to room temperature under a flow of 50 mL/min argon. Each of the reacted samples is labeled as Examples 57-61, respectively.

TABLE 5
Effects of transitional metals on graphene nanomaterial
production at the temperature of 1000° C. for 1 hour.

| Example | Precursor | Metals | Graphene nanomaterial Yield (%) |
|---|---|---|---|
| Example 57 | Example 12 | Ni | 45.2 ± 0.7 |
| Example 58 | Example 13 | Cu | 52.1 ± 0.6 |
| Example 59 | Example 14 | Co | 55.3 ± 0.9 |
| Example 60 | Example 15 | Mo | 59.7 ± 1.0 |
| Example 61 | Example 16 | W | 60.2 ± 0.7 |

### Examples 62-65

Examples 62-65 illustrate the effects of different metal catalysts on graphene nanomaterial production.

Fifty grams (50 g) of the different metals-impregnated kraft lignin samples from each of Examples 17-20 are packed in the middle of a 2-inch OD ceramic tubular reactor. The carrier gas—argon (99.9% purity), is first introduced into the reactor at a flow rate of 50 mL/min for 30 minutes. The reactor is temperature-programmed with a heating rate of 2.5° C./min to 300° C. and kept at 300 ° C. for 30 minutes. The furnace is then continually heated up by 30° C./min to 1000° C. with the welding gas of 50 mL/min argon and 80 mL/min CH₄ and kept at 1000° C. for 1 hour under the welding flow gases. The furnace is cooled down by 10° C./min to room temperature under a flow of 50 mL/min argon. Each of the reacted samples is labeled as Examples 62-65, respectively.

TABLE 6
Effects of iron resources on graphene nanomaterial production
at the temperature of 1000° C. for 1 hour.

| | | | Graphene |
|---|---|---|---|
| Example | Precursor | Iron resources | nanomaterial yield (%) |
| Example 62 | Example 21 | FeCl₃ | 52.3 ± 1.0 |
| Example 63 | Example 22 | FeCl₂ | 51.5 ± 1.2 |
| Example 64 | Example 23 | Iron oxide powder | 50.1 ± 0.7 |
| Example 65 | Example 24 | Iron powder | 49.3 ± 0.8 |

### Examples 66-69

Examples 66-69 illustrate the effects of different welding molecules on graphene nanomaterial production.

Effects of different welding gases—hydrogen (H₂), methane (CH₄), carbon dioxide (CO₂), and natural gas (NG), on production yield of graphene materials from lignin are evaluated. Fifty grams (50 g) of Example 40 sample are packed in the middle of a 2-inch OD ceramic tubular reactor in each run. The welding gas is introduced into the reactor. The reactor is temperature-programmed with a heating rate of 30° C./min to 1000° C. and kept at 1000 ° C. for 1 hour. The furnace is cooled down by 10° C./min to room temperature. Each of the reacted samples is labeled as Examples 66-69, respectively.

TABLE 7
Effects of purging gas on graphene nanomaterial production at
the temperature of 1000° C. for 1 hour.

| | | Welding gas | | |
|---|---|---|---|---|
| | | | Welding | Graphene |
| | | Ar | molecular gas | nanomaterial |
| Example | Precursor | (mL/min) | (mL/min) | yield (%) |
| Example 50 | Example 40 | 50 | CH₄ 80 | 75.3 ± 0.4 |
| Example 66 | Example 40 | 50 | H₂ 80 | 60.1 ± 0.5 |
| Example 67 | Example 40 | 50 | 0 | 62.3 ± 0.5 |
| Example 68 | Example 40 | 50 | NG 80 | 77.1 ± 0.8 |
| Example 69 | Example 40 | 50 | CO₂ 80 | 56.2 ± 0.5 |

### Examples 68 and 70-73

Examples 68 and 70-73 illustrate the effects of temperature ramp rate on graphene nanomaterial production.

Heating rate is an important factor in determining biomass thermal product yields. Effects of different temperature ramp rates—2.5, 5, 10, 20 and 30° C./min on graphene material yield are evaluated. One hundred fifty grams (150 g) of Example 40 sample are packed in the middle of a 2-inch OD ceramic tubular reactor in each run. The purging gas is introduced into the reactor at a flow rate of 80 mL/min. The reactor is temperature-programmed with five different heating rates of 2.5, or 5, or 10, or 20, or 30° C./min to 1000° C., respectively, and all kept at 1000° C. for 1 hour. The furnace is cooled down by 10° C./min to room temperature. Each of the prepared samples is labeled as Examples 68, 70-73, respectively.

TABLE 8
Effects of temperature ramp rate on graphene nanomaterial production.

| | | | Welding gas | | |
|---|---|---|---|---|---|
| | | Temperature | flow rate | | Graphene |
| | | ramp rate | (mL/min) | | nanomaterial |
| Example | Precursor | (° C./min) | Ar | NG | yield (%) |
| Example 70 | Example 40 | 2.5 | 50 | 80 | 74.2 ± 0.7 |
| Example 71 | Example 40 | 5 | 50 | 80 | 75.0 ± 0.8 |
| Example 68 | Example 40 | 10 | 50 | 80 | 77.1 ± 0.8 |
| Example 72 | Example 40 | 20 | 50 | 80 | 78.3 ± 0.5 |
| Example 73 | Example 40 | 30 | 50 | 80 | 76.6 ± 0.7 |

Our results show that higher temperature ramp rate will promote the formation of graphene structure. During lignin catalytic thermal carbonization process, C—O, C═O, C—C and C—H bonds are first catalytically broken down and volatiles (CO₂, CO, H₂O, H₂, and CH₄) are released. Some active carbon species like carbene form, and then bond each other to form C═C structure around catalyst particles. If the temperature ramp rate is lower, catalyst particles are trapped inside a tightly condensed carbon shell. This prevents the further catalytic function of the catalyst. Catalyst particles won't be sealed by carbon shell if the temperature ramp rate is fast enough, therefore, catalytic function can be kept during further reaction.

### Examples 67-68 and 74-77

Examples 67-68 and 74-77 illustrate the effects of purging gas flow rate on graphene nanomaterial production.

Three purging gas flow rates, 80, 150, and 300 mL/min are evaluated. Fifty grams (50 g) of Example 40 sample are packed in the middle of a 2-inch OD ceramic tubular reactor in each run. The purging gas (either argon or NG) is introduced into the reactor. The reactor is temperature-programmed with a heating rate of 10° C./min to 1000° C. and kept at 1000° C. for 1 hour. The furnace is cooled down by 10° C./min to room temperature. Each of the prepared samples is labeled as Examples 67-68, 74-77, respectively.

TABLE 9
Effects of iron resources on graphene nanomaterial production
at the temperature of 1000° C. for 1 hour.

| | |
|---|---|
| Welding gas | |
| Flow rate | Yield to |
| (mL/min) | graphene |

| Example | Precursor | Ar | NG | nanomaterials |
|---|---|---|---|---|
| Example 67 | Example 40 | 80 | 0 | 62.3 ± 0.5 |
| Example 74 | Example 40 | 150 | 0 | 59.7 ± 0.7 |
| Example 75 | Example 40 | 300 | 0 | 55.6 ± 0.5 |
| Example 68 | Example 40 | 50 | 80 | 77.1 ± 0.8 |
| Example 76 | Example 40 | 50 | 150 | 78.5 ± 0.7 |
| Example 77 | Example 40 | 50 | 300 | 77.6 ± 1.0 |

### Examples 68 and 78-81

Examples 68 and 78-81 illustrate the effects of thermal treatment time on graphene nanomaterial production.

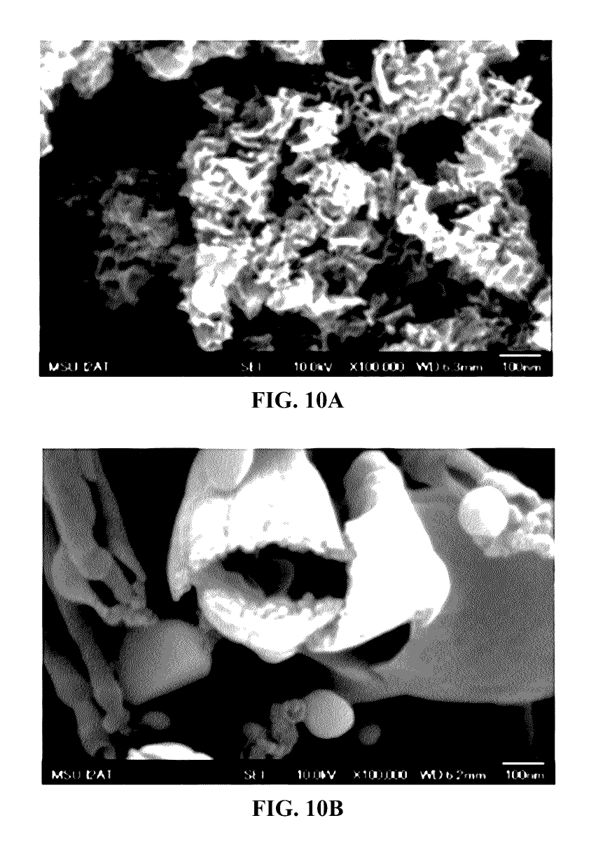

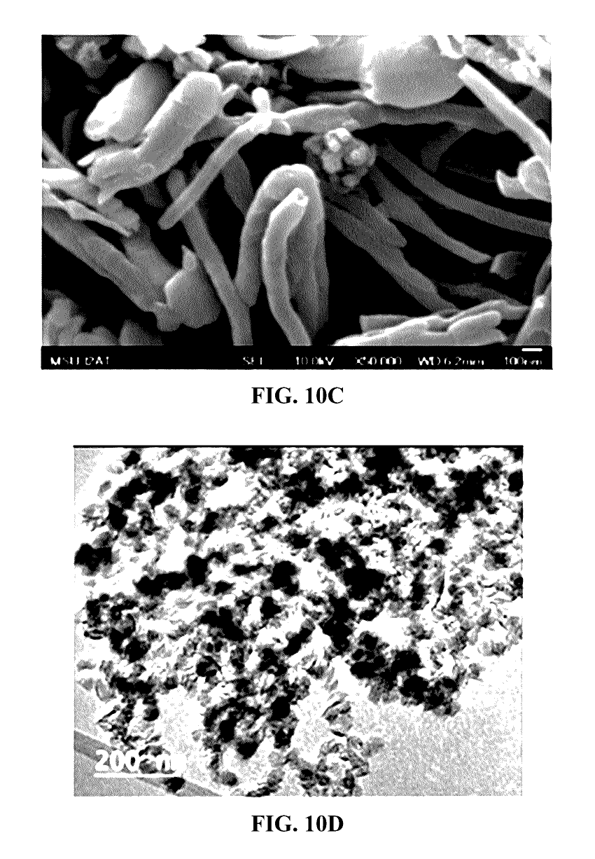

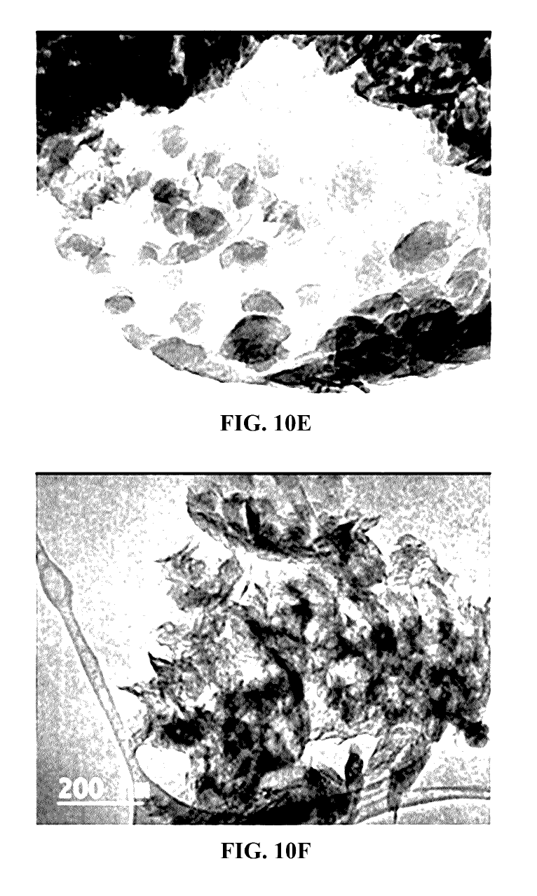

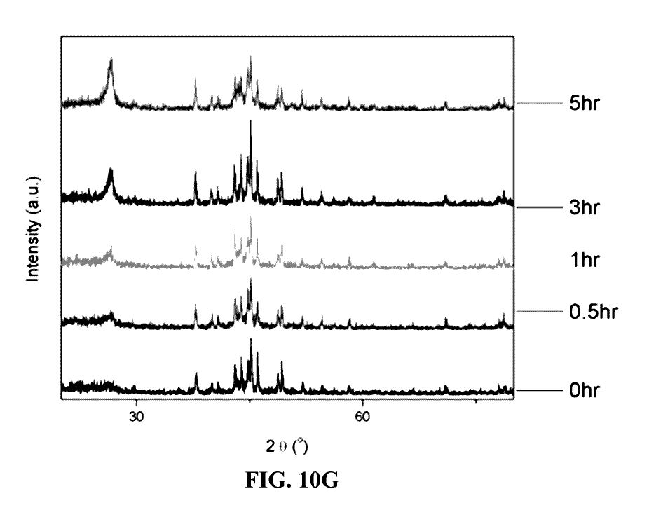

Effects of different thermal treatment times—0, 0.5, 1, 3, and 5 hours, on graphene material yield are evaluated. Fifty grams (50 g) of Example 40 sample are packed in the middle of a 2-inch OD ceramic tubular reactor in each run. The welding gas is introduced into the reactor. The reactor is temperature-programmed with a heating rate of 10° C./min to 1000° C. and kept at 1000° C. for 0, 0.5, 1, 3, or 5 hours. The furnace is cooled down by 10° C./min to room temperature. Each of the prepared samples is labeled as Examples 68, and 78-81, respectively. FIGS. 10A-G demonstrate XRD, SEM, and TEM results of the products under different thermal treatment time. In particular, FIGS. 10A-C illustrate SEM images of products with thermal treatment time of 1 hour (FIG. 10A), 3 hours (FIG. 10B), and 5 hours (FIG. 10C); FIGS. 10D-F illustrate TEM images of products with thermal treatment time of 1 hour (FIG. 10D), 3 hours (FIG. 10E), and 5 hours (FIG. 10F); and FIG. 10G illustrates an XRD plot of the different thermal treatment times.

TABLE 10
Effects of thermal treatment time on graphene nanomaterial
production at the temperature of 1000° C. for 1 hour.

| | | Welding gas | | | |
|---|---|---|---|---|---|
| | | Flow rate | | Thermal | Graphene |
| | | (mL/min) | | treatment time | nanomaterial |
| Example | Precursor | Ar | NG | (hr) | yield (%) |
| Example 78 | Example 40 | 50 | 80 | 0 | 74.2 ± 0.3 |
| Example 79 | Example 40 | 50 | 80 | 0.5 | 75.8 ± 0.5 |
| Example 68 | Example 40 | 50 | 80 | 1 | 77.1 ± 0.8 |
| Example 80 | Example 40 | 50 | 80 | 3 | 80.6 ± 0.9 |
| Example 81 | Example 40 | 50 | 80 | 5 | 85.2 ± 1.1 |

### Examples 50 and 82-87

Examples 50 and 82-87 illustrate the effects of thermal heating temperature on graphene nanomaterial production.

Effects of different heating temperatures—500, 600, 750, 850, 900, 950 and 1000° C. on graphene material yields are evaluated. Fifty grams (50 g) of Example 40 sample are packed in the middle of a 2-inch OD ceramic tubular reactor in each run. The welding gas is introduced into the reactor. The reactor is temperature-programmed with a heating rate of 10° C./min to the desired heating temperature and kept at that temperature for 1 hours. The furnace is cooled down by 10° C./min to room temperature. Each of the prepared samples is labeled as Examples 50, and 82-87, respectively.

TABLE 11
Effects of heating temperature on graphene nanomaterial
production at the temperature of 1000° C. for 1 hour.

| | | Welding gas | | Thermal | |
|---|---|---|---|---|---|
| | | Flow rate | | heating | Graphene |
| | | (mL/min) | | temperature | nanomaterial |
| Example | Precursor | Ar | CH₄ | (° C.) | yield (%) |
| Example 82 | Example 40 | 50 | 80 | 500 | 86.5 ± 0.5 |
| Example 83 | Example 40 | 50 | 80 | 600 | 81.6 ± 0.5 |
| Example 84 | Example 40 | 50 | 80 | 750 | 75.7 ± 0.3 |
| Example 85 | Example 40 | 50 | 80 | 850 | 70.7 ± 0.4 |
| Example 86 | Example 40 | 50 | 80 | 900 | 65.1 ± 0.3 |
| Example 87 | Example 40 | 50 | 80 | 950 | 67.6 ± 0.5 |
| Example 50 | Example 40 | 50 | 80 | 1000 | 75.3 ± 0.4 |

### Examples 88-92

Examples 88-92 illustrate the effects of precursor particle size on graphene material production.

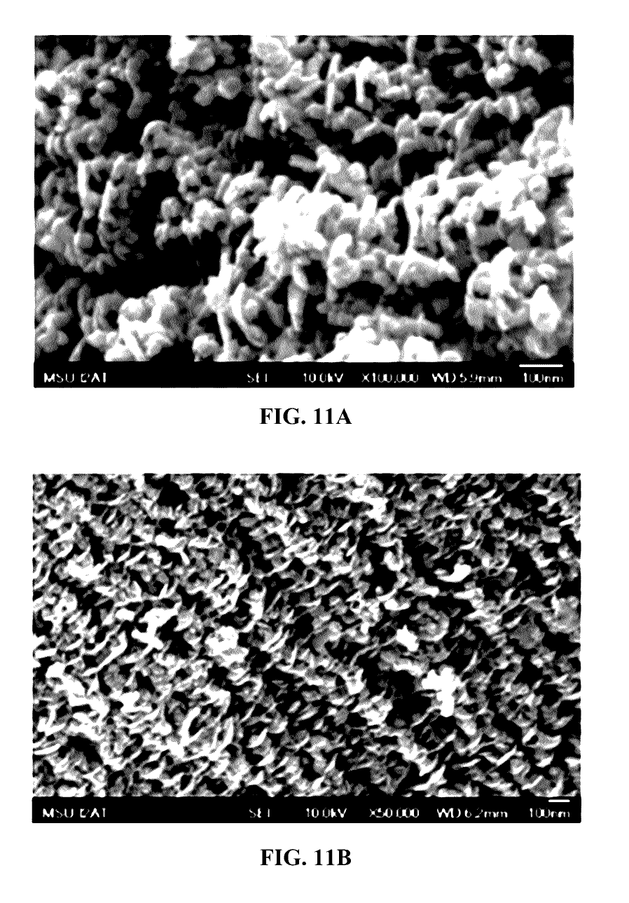

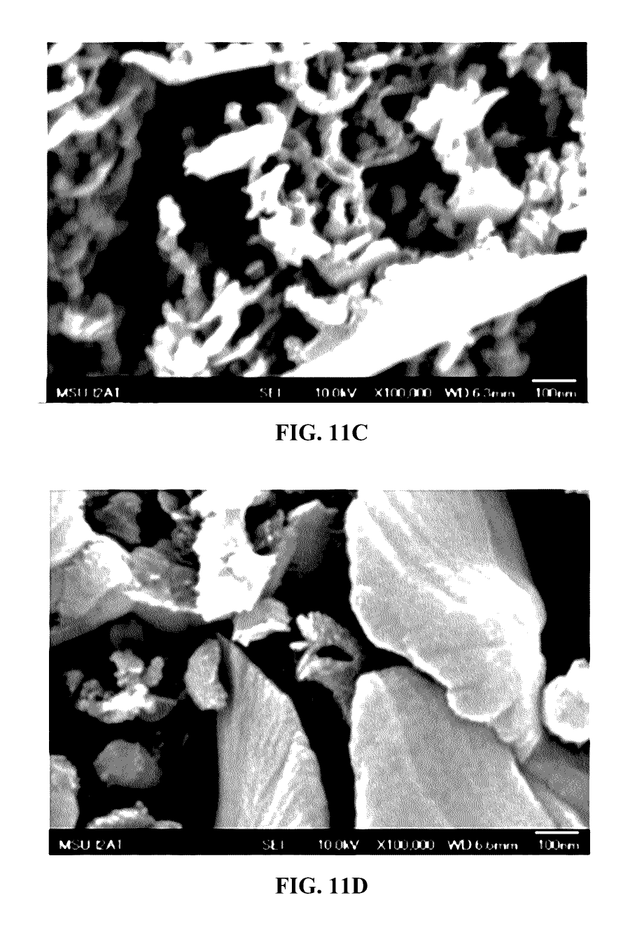

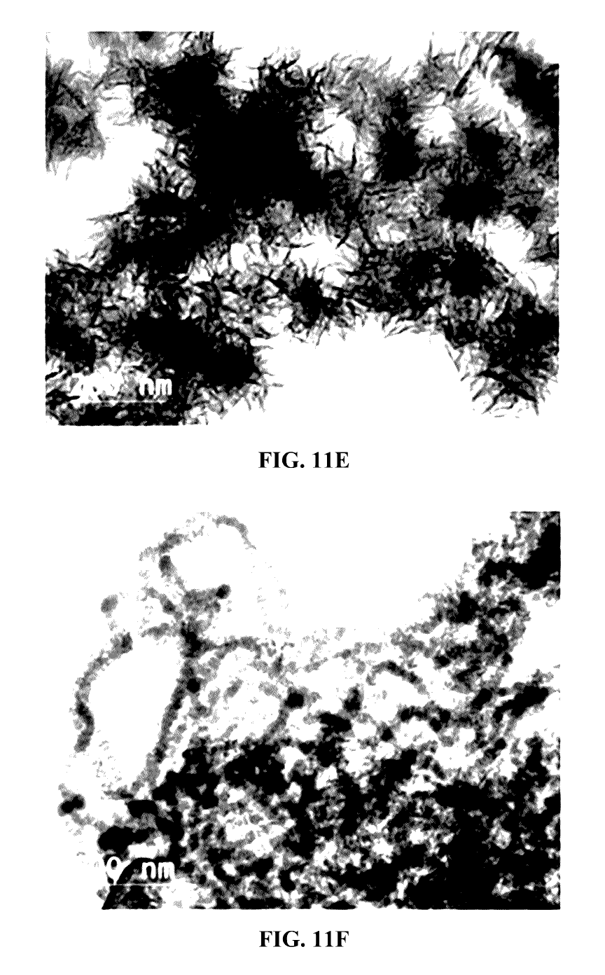

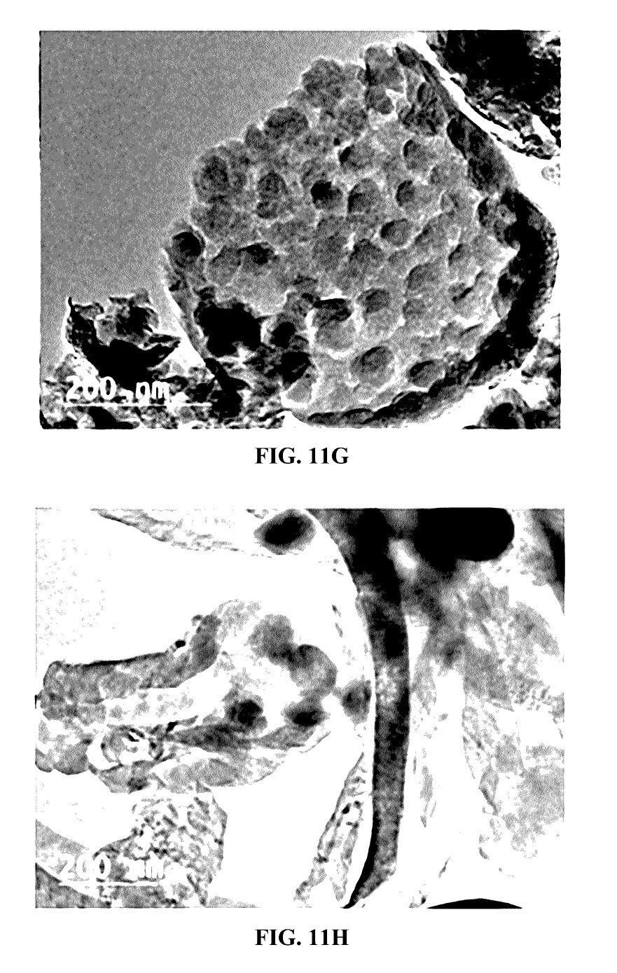

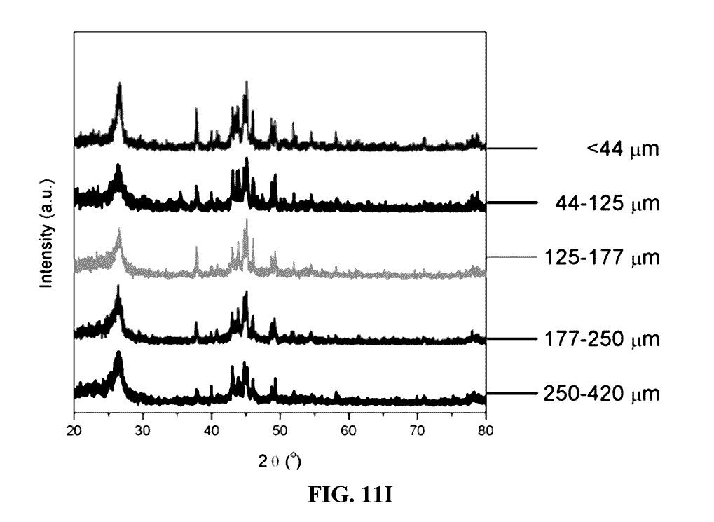

Sample from Example 40 is separated to different size: ≦44, 44-125, 125-177, 177-250, 250-420 μm. Fifty grams (50 g) of each of five size samples are packed in the middle of a 2-inch OD ceramic tubular reactor in each run. The welding gas is introduced into the reactor. The reactor is temperature-programmed with a heating rate of 10° C./min to 1000° C. and kept at 1000° C. for 1 hour. The furnace is cooled down by 10° C./min to room temperature. Each of the prepared samples is labeled as Examples 88-92, respectively. FIGS. 11A-I demonstrate XRD, SEM, and TEM results of the products with different precursor particle size. In particular, FIGS. 11A-D illustrate SEM images of products with precursor sizes of between 250 and 420 μm (FIG. 11A), 177 and 250 μm (FIG. 11B), 125 and 177 μm (FIG. 11C), and 44 and 125 μm (FIG. 11D); FIGS. 11E-H illustrate TEM images of products with precursor sizes of between 250 and 420 μm (FIG. 11E), 177 and 250 μm (FIG. 11F), 125 and 177 μm (FIG. 11G), and 44 and 125 μm (FIG. 11H); and FIG. 11I illustrates an XRD plot of the different precursor sizes.

TABLE 12
Effects of the precursor particle size on graphene nanomaterial
production at the temperature of 1000° C. for 1 hour.

| | | Purging gas | | | |
|---|---|---|---|---|---|
| | | Welding gas | | | |
| | | flow rate | | Precursor | Graphene |
| | | (mL/min) | | particle size | nanomaterial |
| Example | Precursor | Ar | CH₄ | (μm) | yield (%) |
| Example 88 | Example 40 | 50 | 80 | ≦44 | 78.1 ± 0.5 |
| Example 89 | Example 40 | 50 | 80 | 44-125, | 76.3 ± 0.3 |
| Example 90 | Example 40 | 50 | 80 | 125-177 | 75.7 ± 0.5 |
| Example 91 | Example 40 | 50 | 80 | 177-250 | 75.1 ± 0.7 |
| Example 92 | Example 40 | 50 | 80 | 250-420 | 74.6 ± 0.5 |

### Examples 45 and 93-95

Examples 45 and 93-95 illustrate the effects of different lignin sources on graphene nanomaterial productions.

Fifty grams (50 g) of the iron-impregnated lignin sample from each of Examples 21-23, are packed in the middle of a 2-inch OD ceramic tubular reactor. The carrier gas—argon (99.9% purity), is first introduced into the reactor at a flow rate of 50 mL/min for 30 minutes. The reactor is temperature-programmed with a heating rate of 2.5° C./min to 300° C. and kept at 300° C. for 30 minutes. The furnace is then continually heated up by 30° C./min to 1000° C. with the welding gas of 50 mL/min argon and 80 mL/min CH₄ and kept at 1000° C. for 1 hour under the welding flow gases. The furnace is cooled down by 10° C./min to room temperature under a flow of 50 mL/min argon. Each of the reacted samples is labeled as Examples 45, 93-95, respectively.

TABLE 13
Effects of lignin resources on graphene nanomaterial production

| | | Graphene nanomaterial |
|---|---|---|
| Example | Precursor | yield (%) |
| Example 45 | Example 5 | 55.1 ± 0.5 |
| Example 93 | Example 21 | 55.5 ± 0.4 |
| Example 94 | Example 22 | 52.7 ± 0.9 |
| Example 95 | Example 23 | 53.5 ± 0.7 |

Structural Parameters

VI. Graphene Materials Structure Analysis

Currently, graphene materials characterization mainly depends on electron microscopy techniques, e.g., SEM and TEM, Raman spectroscopy, and XRD. SEM technique can be used to obtain the overall morphology information of graphene materials. HRTEM technique can be used to get the detail information fringes structure. The XRD technique is a good method to evaluate the average structure parameters (such as lateral size and thickness) of graphene materials, and which can also be used to rough estimation the relative content of graphitic materials. The crystallite thickness (Lc) was calculated from the (002) band at half maximum intensity by applying Scherrer equation:

$${L}_{c} = \frac{K λ}{B cos θ}$$

Where λ is the wavelength of incident X-rays, K is 0.89, B and θ correspond to the full width at half maximum (FWHM) and the Bragg angle of the peak respectively. The Raman technique is a good method for recognizing the defects in graphene materials. The crystal diameter (also been called lateral size, La) of graphene materials also can be calculated by D and G bands as shown in the equation 1:

$$La ( nm ) = ( 2.4 \times {10}^{- 10} ) {λ}^{4} ( \frac{{I}_{G}}{{I}_{D}} )$$

Where, λ is the wavelength of the laser, I_{G} and I_{D} are the intensity of G and D band, respectively.

To evaluate the quality and quantity analysis the structure parameters, our graphene materials (Example 68, Example 78 to 81, and Example 88 to 92) were characterized by XRD, Raman, SEM, and TEM. Meanwhile, two commercial materials (Example C1 and C2) were also characterized as comparison. The structure parameters of graphene materials are list in Table 14.

TABLE 14
Structure parameters of graphene materials

| | Instrument | | | |
|---|---|---|---|---|
| | XRD | Raman | SEM | TEM |
| Example | Lc (nm) | La (nm) | Particle size (um) | Layers |
| Example 68 | 6 | 19 | 0.5-10 | 9 |
| Example 78 | 4 | 13 | 0.5-5 | 6 |
| Example 79 | 5 | 16 | 0.5-10 | 7 |
| Example 80 | 9 | 28 | 0.5-10 | 12 |
| Example 81 | 13 | 35 | 0.5-10 | 16 |
| Example 88 | 12 | 37 | 0.5-20 | 30 |
| Example 89 | 6 | 19 | 0.5-10 | 25 |
| Example 90 | 7 | 22 | 0.5-10 | 20 |
| Example 91 | 6 | 19 | 0.5-10 | 13 |
| Example 92 | 6 | 18 | 0.5-10 | 10 |
| Example C1* | 21 | 164 | 1-30 | 27 |
| Example C2* | 0.7 | 19 | 1-20 | 5 |

*Example C1 and C2 are commercial graphene materials which made from CVD and thermal chemical exfoliation process, respectively.

In view of the above, it will be seen that the several advantages of the disclosure are achieved and other advantageous results attained. As various changes could be made in the above methods without departing from the scope of the disclosure, it is intended that all matter contained in the above description and shown in the accompanying drawings shall be interpreted as illustrative and not in a limiting sense.

### REFERENCES

Throughout this document, various references are mentioned. All such references, including those listed below, are incorporated herein by reference.
X. Du, P. Guo, H. Song, X. Chen, Graphene nanosheets as electrode material for electric double-layer capacitors, ElectrochimicaActa. 55 (2010) 4812-4819. doi:10.1016/j.electacta.2010.03.047.
S. P. Mun, Z. Cai, J. Zhang, Fe-catalyzed thermal conversion of sodium lignosulfonate to graphene, Mater. Lett. 100 (2013) 180-183. doi:10.1016/j.matlet.2013.02.101.
Y. Du, C. Wang, H. Toghiani, Z. Cai, X. Liu, J. Zhang, et al., Synthesis of carbon-encapsulated metal nanoparticles from wood char, For. Prod. J. 60 (2010) 527-533.
J. Huo, H. Song, X. Chen, Preparation of carbon-encapsulated iron nanoparticles by co-carbonization of aromatic heavy oil and ferrocene, Carbon. 42 (2004) 3177-3182. doi:10.1016/j.carbon.2004.08.007.
X. L. Dong, Z. D. Zhang, Q. F. Xiao, X. G. Zhao, Y. C. Chuang, S. R. Jin, et al., Characterization of ultrafine γ-Fe (C), α-Fe (C) and Fe3C particles synthesized by arc-discharge in methane, J. Mater. Sci. 33 (1998) 1915-1919.
H. Kim, W. Sigmund, Effect of a graphitic structure on the stability of FCC iron, J. Cryst. Growth. 267 (2004) 738-744. doi:10.1016/j.jcrysgro.2004.04.021.
H. Kim, W. Sigmund, Effect of a graphitic structure on the stability of FCC iron, J. Cryst. Growth. 267 (2004) 738-744. doi:10.1016/j.jcrysgro.2004.04.021.
K. Wieczorek-Ciurowa, A. J. Kozak, The Thermal Decomposition of Fe(NO3)3·9H₂O, J. Therm. Anal. Calorim. 58 (1999) 647-651. doi:10.1023/A:1010112814013.
M. Zhao, H. Song, X. Chen, W. Lian, Large-scale synthesis of onion-like carbon nanoparticles by carbonization of phenolic resin, Acta Mater. 55 (2007) 6144-6150. doi:10.1016/j.actamat.2007.07.013.
Z. He, J.-L. Maurice, A. Gohier, C. S. Lee, D. Pribat, C. S. Cojocaru, Iron Catalysts for the Growth of Carbon Nanofibers: Fe, Fe3C or Both?, Chem. Mater. 23 (2011) 5379-5387. doi:10.1021/cm202315j.
H. Yoshida, S. Takeda, T. Uchiyama, H. Kohno, Y. Homma, Atomic-Scale In-situ Observation of Carbon Nanotube Growth from Solid State Iron Carbide Nanoparticles, Nano Lett. 8 (2008) 2082-2086. doi:10.1021/nl080452q.
Y. Xue, B. Wu, Y. Guo, L. Huang, L. Jiang, J. Chen, et al., Synthesis of large-area, few-layer graphene on iron foil by chemical vapor deposition, Nano Res. 4 (2011) 1208-1214. doi:10.1007/s12274-011-0171-4.
S. P. Mun, Z. Cai, J. Zhang, Preparation of Fe-cored carbon nanomaterials from mountain pine beetle-killed pine wood, Mater. Lett. 142 (2015) 45-48. doi:10.1016/j.matlet.2014.11.053.

What is claimed is:

1. A method of synthesizing carbon-based materials, the method comprising:
providing precursors;
forming carbon-encapsulated metal structures from the precursors; and
forming nano-shell structure-based graphene materials from the carbon-encapsulated metal structures.

2. The method of claim 1, wherein providing the precursors comprises preparing the precursors.

3. The method of claim 2, wherein preparing the precursors comprises mixing a biomass and a catalyst.

4. The method of claim 3, wherein the biomass is selected from the group consisting of kraft lignin, organosolv lignin, lignosulfonates, hydrolytic lignin, black liquor, and combinations thereof.

5. The method of claim 3, wherein the biomass is selected from the group consisting of woody biomass and its derivatives, wood chips, wood char, wood-based chars, pyrolysis char, starch, wood-derived sugars, active carbon, carbon black, and combinations thereof.

6. The method of claim 3, wherein the biomass is dispersed in a solvent selected from the group consisting of water, ethanol, acetone, 1,3-dioxane, 1,4-dioxane, tetrahydrofuran, and combinations thereof.

7. The method of claim 3, wherein the catalyst is selected from the group consisting of a metal catalyst, a bi-metallic catalyst, a tri-metallic catalyst, a tetra-metallic catalyst, and any other multi-metal catalyst.

8. The method of claim 7, wherein the metal catalyst is selected from the group consisting of transition metals, salts thereof, oxides thereof, and combinations thereof.

9. The method of claim 7, wherein the metal catalyst is a combination of metals selected from the group consisting of Fe, Cu, Ni, Co, Mo, W, salts thereof, oxides thereof, and combinations thereof.

10. The method of claim 3, wherein mixing the biomass and the catalyst includes mixing between 2.5% and 30% by weight catalyst with between 70% and 97.5% by weight biomass.

11. The method of claim 3, wherein mixing the biomass and the catalyst forms a catalyst-impregnated biomass.

12. The method of claim 1, wherein forming the carbon-encapsulated metal structures comprises thermally treating the precursors.

13. The method of claim 1, wherein forming nano-shell structure-based graphene materials includes opening the carbon-encapsulated metal structures to form shell-like structures, then welding and reconstructing the shell-like structures to form the nano-shell structure-based graphene materials.

14. The method of claim 13, wherein welding and reconstructing the shell-like structures comprises application of a welding reagent gas under high temperature.

15. The method of claim 14, wherein the welding reagent gas is selected from the group consisting of light hydrocarbons, argon, hydrogen, natural gas, other carbonaceous gases, and combinations thereof.

16. The method of claim 14, wherein the high temperature includes a temperature of between 500° C. and 1,500° C.

17. The method of claim 1, further comprising pretreating the precursor prior to forming the carbon-encapsulated metal structures.

18. The method of claim 17, wherein the pretreating is selected from the group consisting of pre-decomposing the precursor, grinding the precursor, and a combination thereof.

19. The method of claim 1, wherein the nano-shell structure-based graphene materials comprise multi-layer graphene-based materials selected from the group consisting of nano-graphene shell connected chains, graphene nanoplatelets, fluffy graphene, flat graphene sheets, curved graphene sheets, graphene sponges, graphene-encapsulated metal, metal carbide nanoparticles, graphene strips with a common metal joint, and combinations thereof.

20. The method of claim 1, further comprising post-treating the graphene materials with water, steam, carbon dioxide, hydrogen sulfide, carbon disulfide, ammonia, a basic solution, or an acid solution.

21. The method of claim 1, further comprising purifying the graphene materials with water, steam, carbon dioxide, hydrogen sulfide, carbon disulfide, ammonia, a basic solution, or an acid solution.

22. The method of claim 20, further comprising purifying the graphene materials with water, steam carbon dioxide, hydrogen sulfide, carbon disulfide, ammonia, a basic solution, or an acid solution.

23. A method of synthesizing carbon-based materials, the method comprising:
preparing precursors from a biomass and a catalyst;
forming carbon-encapsulated metal structures from the precursors, the forming of the carbon-encapsulated metal structures including thermally treating the precursors; and
forming nano-shell structure-based graphene materials from the carbon-encapsulated metal structures, the forming of the nano-shell structure based graphene materials including opening the carbon-encapsulated metal structures to form shell-like structures, then welding and reconstructing the shell-like structures to form the nano-shell structure-based graphene materials;
wherein the biomass is selected from the group consisting of kraft lignin, organosolv lignin, lignosulfonates, black liquor, hydrolytic lignin, woody biomass and its derivatives, wood ships, wood char, wood-based chars, pyrolysis char, starch, wood-derived sugars, active carbon, carbon black, and combinations thereof; and
wherein the catalyst is at least one transition metal.

24. The method of claim 23, wherein mixing preparing the precursors includes forming a catalyst-impregnated biomass.

25. The method of claim 23, further comprising post-treating the graphene materials with water, steam, carbon dioxide, hydrogen sulfide, carbon disulfide, ammonia, a basic solution, or an acid solution.

26. The method of claim 23, further comprising purifying the graphene materials with water, steam, carbon dioxide, hydrogen sulfide, carbon disulfide, ammonia, a basic solution, or an acid solution.

27. The method of claim 25, further comprising purifying the graphene materials with water, steam carbon dioxide, hydrogen sulfide, carbon disulfide, ammonia, a basic solution, or an acid solution.

28. A method of synthesizing carbon-based materials, the method comprising:
preparing precursors from a kraft lignin and a transition metal catalyst;
pretreating the precursors;
forming carbon-encapsulated metal structures from the precursors, the forming of the carbon-encapsulated metal structures including thermally treating the precursors; and
forming nano-shell structure-based graphene materials from the carbon-encapsulated metal structures, the forming of the nano-shell structure based graphene materials including opening the carbon-encapsulated metal structures to form shell-like structures, then welding and reconstructing the shell-like structures to form the nano-shell structure-based graphene materials.

29. The method of claim 28, further comprising post-treating the graphene materials with water, steam, carbon dioxide, hydrogen sulfide, carbon disulfide, ammonia, a basic solution, or an acid solution.

30. The method of claim 28, further comprising purifying the graphene materials with water, steam, carbon dioxide, hydrogen sulfide, carbon disulfide, ammonia, a basic solution, or an acid solution.

31. The method of claim 29, further comprising purifying the graphene materials with water, steam carbon dioxide, hydrogen sulfide, carbon disulfide, ammonia, a basic solution, or an acid solution.

32. A method of synthesizing carbon-encapsulated metal structures, the method comprising:
preparing precursors from a biomass and a catalyst;
optionally pretreating the precursors; and
thermally treating the precursors to form carbon-encapsulated metal structures.
